(19) United States
(12) Patent Application Publication
(10) Pub. No.: US 2026/0278984 A1
(43) Pub. Date: Sep. 17, 2026

(54) SYSTEM

(71) Applicant: SoftBank Group Corp., Tokyo (JP)

(72) Inventor: Yumiko KUBO, Tokyo (JP)

(73) Assignee: SoftBank Group Corp., Tokyo (JP)

(21) Appl. No.: 19/550,560

(22) Filed: Feb. 26, 2026

Related U.S. Application Data
(60) Provisional application No. 63/771,297, filed on Mar. 13, 2025.

(51) Int. Cl. G06V 10/25; G06N 3/0442; G06N 3/0464; G06N 3/0475; G06N 3/08; G06V 10/764; G06V 10/77; G06V 10/82; G06V 40/20

(52) U.S. Cl. CPC G06V 10/25; G06N 3/0442; G06N 3/0464; G06N 3/0475; G06N 3/08; G06V 10/764; G06V 10/7715; G06V 10/82; G06V 40/23; G06V 40/28; G06V 2201/07

(57) ABSTRACT

A system includes a processor configured to capture images or video of gestures and objects associated with a user and to analyze the captured data using an image recognition unit to identify at least one object and one user action. The processor accesses a language database to retrieve candidate words or phrases related to the identified object and action and presents the candidate words or phrases to the user. Upon selection of a word or phrase, the processor generates a visual communication medium based on the selected word or phrase. The processor further updates at least one of the language database and an algorithm associated with the image recognition or candidate presentation based on user selection history and feedback to improve system accuracy.

### CROSS-REFERENCE TO RELATED APPLICATION

This application is based on and claims priority under 35 USC 119(e) from U.S. Provisional Application No. 63/771,297 filed on Mar. 13, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Many users with language impairments experience significant difficulty in conveying their intentions, needs, and emotions to others in daily life. Conventional communication aids such as text-based message boards, symbol charts, or simple speech-generating devices frequently require substantial cognitive effort, fine motor control, or prior training, and often fail to capture the rich, context-dependent nature of real-world gestures, facial expressions, and interactions with objects. Systems that merely convert limited input signals into predefined phrases do not adequately interpret complex combinations of objects and actions, and therefore cannot reliably infer a user's actual intent. Furthermore, conventional systems typically offer static phrase sets and do not adapt to the user's individual usage patterns, cultural background, or language preferences. As a result, communication remains slow, ambiguous, and frustrating for both the user and the communication partner. There is a need for a system that can (i) automatically recognize objects and actions from images or video of the user's gestures and environment, (ii) generate and present appropriate, personalized language candidates, (iii) produce intuitive visual communication media such as illustrations or comic-style stories based on user-selected phrases, and (iv) continuously learn from the user's selection history and feedback to improve accuracy and usability over time.

### SUMMARY

In order to solve the above-described problems, the present invention provides a system comprising a processor configured to cooperatively control a camera unit, an image recognition unit, a language database unit, a candidate presentation unit, a visual communication generation unit, and a feedback learning unit. The processor controls the camera unit to capture images or video of gestures and objects associated with a user, including the user's hand movements, facial expressions, and surrounding objects, in real time. The processor causes the image recognition unit to analyze the captured images or video using an algorithm based on machine learning, thereby identifying with high accuracy at least one object and at least one action performed by the user and inferring one or more possible user intents. The processor accesses the language database unit storing words and phrases associated with identified objects and actions in a plurality of languages and, in accordance with a language setting and cultural region of the user, retrieves a plurality of candidate words or phrases related to the at least one identified object and the at least one identified action. The processor controls the candidate presentation unit to present the plurality of candidate words or phrases to the user visually, not only in text form but also via an interface including images or illustrations related to the candidate words or phrases, so that the user can easily select at least one candidate. Based on the at least one word or phrase selected by the user, the processor controls the visual communication generation unit to generate a visual communication medium, such as a simple illustration or a comic-style story, that represents the selected content in a form that can be readily understood by a communication partner. In addition, the processor controls the feedback learning unit to record a selection history of the user and feedback regarding a degree of success of communication, and to update at least one of the language database unit and algorithms associated with the image recognition unit, the candidate presentation unit, and other components. Through this feedback-based adaptation, the system progressively improves the relevance and priority of candidate phrases and the quality of generated visual communication media, thereby enabling more efficient, accurate, and personalized support for communication by users with language impairments.

The term “processor” refers to one or more hardware processing units, such as a central processing unit (CPU), microprocessor, digital signal processor, graphics processing unit (GPU), or a combination thereof, capable of executing instructions to control and coordinate operations of the system components described in the claims.

The term “camera unit” refers to any image capturing component or device, including but not limited to a camera integrated in a portable device, a wearable device, or a fixed camera, that is configured to capture images or video of a user's gestures, facial expressions, and surrounding objects.

The term “image recognition unit” refers to a hardware and/or software component configured to analyze captured images or video and to identify at least one object and at least one action by applying an algorithm, such as a machine learning or deep learning algorithm, to recognize objects, gestures, and movements.

The term “language database unit” refers to a storage component, including memory and associated management software, configured to store words and phrases, together with metadata linking such words and phrases to objects, actions, and intents, in one or more languages, and to provide candidate words or phrases according to user-specific settings.

The term “candidate presentation unit” refers to a user interface component, including display hardware and associated control software, configured to present to a user a plurality of candidate words or phrases, in text form and optionally with associated images or illustrations, and to receive a selection of at least one of the candidate words or phrases from the user.

The term “visual communication generation unit” refers to a component that generates a visual communication medium, such as an illustration, icon set, or comic-style story, based on at least one word or phrase selected by the user, by using predetermined templates, drawing routines, or a generative model such as a generative AI image model.

The term “feedback learning unit” refers to a component including software and, optionally, dedicated hardware, configured to record and analyze user-related information such as selection history and feedback regarding communication success, and to update at least one of stored data and algorithms so as to improve the performance and personalization of the system over time.

The term “images or video” refers to digital visual data obtained from the camera unit, including single still images, continuous sequences of frames, or short motion clips, which are suitable for processing by the image recognition unit.

The term “object” refers to any physical item or entity present in the captured images or video, such as a cup, bottle, plate, door, piece of furniture, or other recognizable item that can be detected and labeled by the image recognition unit.

The term “action” refers to a movement or gesture performed by the user or involving an object in the captured images or video, including but not limited to lifting, pointing, waving, moving an object to the mouth, sitting down, or other detectable motions over time.

The term “word or phrase” refers to a unit of language, including a single word, a short expression, or a sentence, which represents or describes an intent, request, state, or message associated with one or more objects or actions identified by the system.

The term “candidate words or phrases” refers to multiple words or phrases retrieved from the language database unit that are determined to be relevant to at least one identified object, action, or inferred intent, and that are presented to the user for selection.

The term “visual communication medium” refers to a visual representation, including but not limited to a single illustration, a sequence of images, a comic-style story, or a symbolic pictogram, that is generated based on at least one selected word or phrase and is intended to convey the user's intention to another person.

The term “selection history” refers to recorded data that indicates which candidate words or phrases have been selected by the user over time, including information such as frequency of selection, timing, and context, and that is used by the feedback learning unit to adapt system behavior.

The term “feedback from the user” refers to information provided directly or indirectly by the user, or by a caregiver or system operator on behalf of the user, indicating the accuracy, usefulness, or success of a selected word or phrase or a generated visual communication medium, and used for improving the system.

The term “degree of success of communication” refers to an assessment, which may be qualitative or quantitative, of how effectively a selected word or phrase and its corresponding visual communication medium enabled the user to convey an intended message to another person.

The term “language setting of the user” refers to configuration information specifying one or more preferred languages in which words and phrases are to be provided or displayed by the system for interaction with the user.

The term “cultural region” refers to information indicating a geographical, cultural, or sociolinguistic context associated with the user, which may influence the selection and prioritization of words, phrases, examples, and visual styles in the system.

The term “portable device camera” refers to a camera integrated into or connected to a mobile or handheld electronic device, such as a smartphone, tablet, or wearable device, which can be carried by the user and used to capture images or video in various environments.

The term “fixed camera” refers to a camera installed at a relatively stationary location, such as in a home, care facility, or public space, that continuously or periodically captures images or video of the user's actions and surrounding environment.

The term “machine learning” refers to computational methods, including but not limited to neural networks, deep learning models, and statistical learning algorithms, that enable the system to automatically learn patterns from data and improve recognition and prediction performance without being explicitly programmed for each possible case.

The term “algorithm associated with the system” refers to a set of computational procedures, models, or rules executed by the processor to perform functions such as image recognition, candidate phrase retrieval, ranking, user interface adaptation, and feedback-based learning within the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5 G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

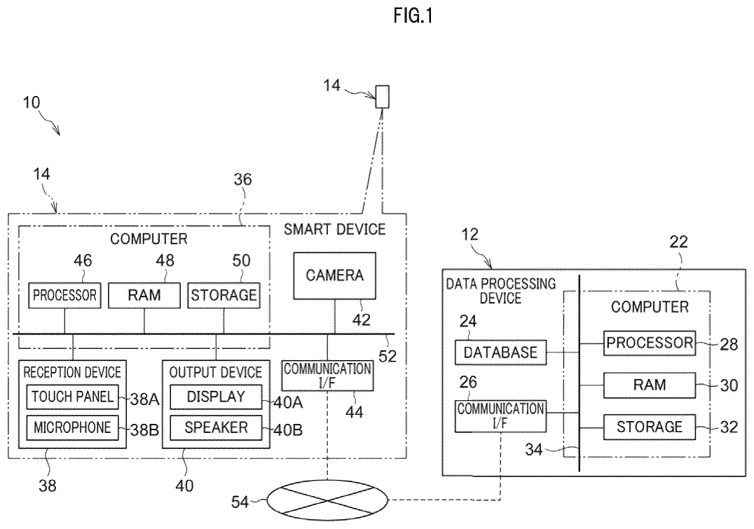

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

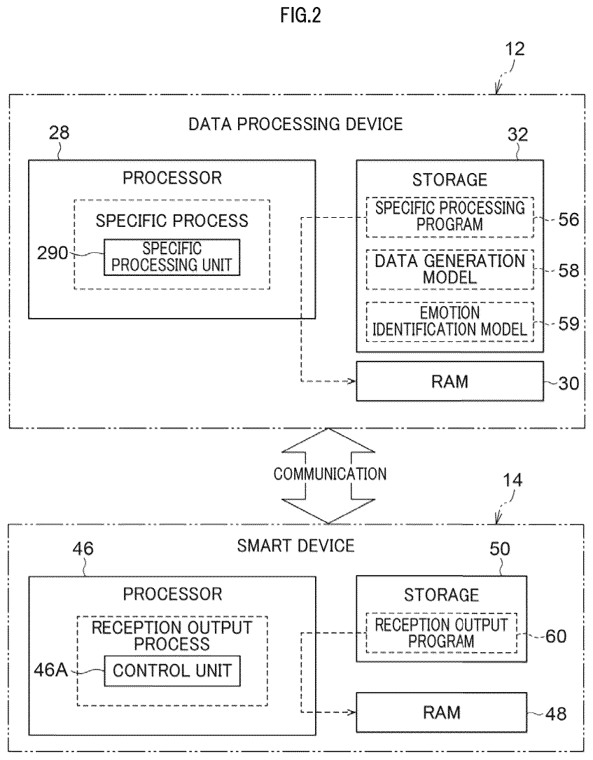

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional assistive communication systems for users with speech or language disabilities typically rely on static symbol boards, manually curated phrase lists, or fixed rule-based mappings between detected inputs and output messages. Such systems suffer from several technical limitations. First, they often process sensor inputs, such as images or video, on a frame-by-frame basis without robust temporal analysis, which leads to inaccurate recognition of complex, continuous user actions (for example, distinguishing “lifting a cup” from “drinking from a cup”). Second, known systems usually employ rigid, manually designed tables to associate recognized actions with candidate phrases, without dynamically adapting to individual user preferences, usage history, or contextual conditions such as time, location, and interaction outcomes. As a result, the ranking and presentation of candidate expressions are often sub-optimal and require repeated manual corrections by the user. Furthermore, many existing systems treat generative artificial intelligence models, if used at all, as a superficial add-on that simply produces decorative images or unrestricted text. These systems do not technically integrate generative models into the core computational pipeline through structured prompt sentence generation, nor do they feed back user interaction and communication success data into the models to refine prompt construction and output selection over time. Consequently, the computational resources of generative models are not exploited to improve recognition-to-expression mapping, and the quality of generated visual content frequently lacks clarity, consistency, and suitability for the specific communication needs of a given user.

In addition, in distributed environments where sensing is performed on a user terminal and heavier computation is offloaded to a remote processor, existing architectures often lack a well-defined division of functions between the devices. This leads to redundant computation, inefficient bandwidth usage, and increased latency when streaming continuous imaging information and returning interaction results in near real time. There is also insufficient technical handling of the way user feedback and communication outcomes are collected, stored, and used to adapt the behavior of the system, including the ranking of candidate expressions and the generation of prompts for generative artificial intelligence models. Accordingly, there is a need for a computer-implemented system and method that: (i) accurately recognizes user actions from time-series imaging information, (ii) dynamically generates and prioritizes candidate linguistic expressions based on recognized actions, user profile information, and context, (iii) constructs structured prompt sentences to control one or more generative artificial intelligence models for producing text and visual communication content, and (iv) continuously adapts the recognition, candidate generation, prioritization, and prompt construction processes based on accumulated interaction and feedback data. Such a system should improve the overall computational pipeline—from sensing to recognition, expression selection, and visual generation—in a way that reduces user burden, improves accuracy and responsiveness, and enhances the effectiveness of computer-mediated interpersonal communication.

The specific processing by the specific processing unit 290 of the data processing device 12 in Example 1 is realized by the following means.

The present invention provides a server comprising a processor and a memory storing instructions, wherein the instructions, when executed by the processor, cause the server to acquire imaging information capturing gestures, facial expressions, and surrounding targets of a user from a terminal over a communication line; to perform temporal analysis on the imaging information to extract targets and motions in a time series and to recognize an action based on continuous posture changes; to store, in an information storage unit, a plurality of expression information items corresponding to recognized actions in association with language types, cultural conditions, and user profile data; to search the stored expression information based on the recognized action, user usage history, and environment information, and to determine candidate expressions with assigned priorities; to generate a prompt sentence for a generative artificial intelligence model based on at least one of a selected candidate expression, the recognized action, the environment information, and the user profile data; to cause the generative artificial intelligence model to generate visual information representing contents of the selected candidate expression in response to the prompt sentence; to provide the candidate expressions and the generated visual information to the terminal for presentation to the user; to acquire, from the terminal, interaction data including user selection results, evaluation information regarding the generated visual information, and communication success information; and to update at least one parameter of a process of searching and prioritizing the candidate expressions and a process of generating the prompt sentence based on accumulated interaction data. This enables an improved computer-implemented communication pipeline that more accurately interprets user actions from time-series imaging information, dynamically customizes and ranks candidate expressions, and adaptively controls generative artificial intelligence models through refined prompt sentences, thereby reducing processing inefficiencies, lowering user burden, and enhancing the effectiveness and reliability of computer-mediated interpersonal communication.

The term “processor” refers to a hardware computation unit, such as a central processing unit or an accelerator, that executes machine-readable instructions to perform operations on data.

The term “imaging information” refers to digital data representing visual scenes, including still images or sequences of images, that capture gestures, facial expressions, objects, and surroundings of a user.

The term “gesture” refers to a physical movement or pose of at least a part of the user's body, including but not limited to hand motions, arm motions, head motions, and body posture changes, which can be interpreted as conveying an intention.

The term “facial expression” refers to a configuration or movement of facial muscles of the user, including, for example, frowning, smiling, or raising eyebrows, that can be captured by imaging information and used to infer emotional or communicative intent.

The term “target” refers to any object, body part, or region within a captured scene that is subject to detection, tracking, or recognition by the system.

The term “time series” refers to a sequence of data points, including image frames, ordered in time and processed to analyze temporal changes of targets and motions.

The term “motion” refers to a change in position, orientation, or configuration of a target over time, as derived from successive elements of the time series of imaging information.

The term “action” refers to a higher-level interpretation of one or more motions and postures over a period of time, such as drinking, pointing, waving, or greeting, inferred from temporal analysis of imaging information.

The term “continuous posture changes” refers to successive variations in the position and orientation of a user's body or body parts over multiple time steps, used to derive an action from a sequence of poses.

The term “information storage unit” refers to any memory or data storage component, including volatile or non-volatile storage, that stores expression information, profile data, environment information, or learned parameters.

The term “expression information” refers to data representing linguistic expressions, such as words, phrases, or sentences, which are associated with recognized actions, objects, or contexts and are used as candidate outputs for communication.

The term “language type” refers to a classification of expression information according to a natural language, such as a national or regional language, in which a phrase or sentence is written or spoken.

The term “cultural condition” refers to information indicating cultural, regional, or social context, such as country, region, or customary behavior patterns, used to adapt expression information to a user's background.

The term “user profile data” refers to stored information specific to an individual user, including preferences, language settings, frequently used expressions, and other personalization parameters.

The term “environment information” refers to data describing contextual conditions surrounding the user, including, for example, time of day, location, interaction history, or recognized objects present in the scene.

The term “candidate expression” refers to an item of expression information selected as a potential output to represent a recognized action or intent to the user, prior to final user selection.

The term “priority” refers to a value or ranking associated with a candidate expression that indicates the order or prominence with which the candidate expression is presented to the user.

The term “terminal” refers to a user-side device, such as a portable information processing apparatus or a fixed installation-type apparatus, that captures imaging information, displays candidate expressions or visual information, and receives user inputs.

The term “communication line” refers to any wired or wireless data transmission medium, including packet-based networks, used to transfer information between the terminal and the server.

The term “prompt sentence” refers to a structured text input, generated by the system, that describes required content, style, or constraints and is supplied to a generative artificial intelligence model to control its output.

The term “generative artificial intelligence model” refers to a machine learning model that generates new content, including visual or textual information, based on input conditions such as a prompt sentence and learned parameters.

The term “visual information” refers to image data, graphic data, or a sequence of images, including illustrations or story-form visual content, intended for human viewing.

The term “image information” refers to visual information representing at least one frame or still image, including, for example, raster image data encoded in a digital format.

The term “story-form visual information” refers to visual information comprising multiple related images or panels arranged to depict a sequence of events or actions in a narrative style.

The term “interaction data” refers to data collected from user interactions with the system, including candidate expression selections, feedback inputs, usage patterns, and communication outcomes.

The term “evaluation information” refers to explicit or implicit feedback from the user or a related party regarding the usefulness, clarity, or appropriateness of presented candidate expressions or generated visual information.

The term “communication success information” refers to data indicating whether a particular interaction, involving selected candidate expressions and visual information, resulted in a successful interpersonal communication outcome.

The term “learning data” refers to stored interaction data, evaluation information, and communication success information that are used to train or adjust models, parameters, or rules in the system.

The term “searching and prioritizing process” refers to a computational procedure in which stored expression information is retrieved and ranked in response to recognized actions, user history, and environment information to determine candidate expressions and their priorities.

The term “prompt sentence generating process” refers to a computational procedure in which the system constructs or modifies a prompt sentence for a generative artificial intelligence model based on selected candidate expressions, recognized actions, environment information, and user profile data.

The term “processing apparatus” refers to a computing device or subsystem that performs at least part of the extraction, recognition, search, ranking, and generation processes described in the system.

The term “display input/output apparatus” refers to a device or subsystem including at least one display unit and at least one input unit, configured to present candidate expressions and visual information to the user and to receive input operations from the user.

The term “text generative AI model” refers to a generative artificial intelligence model specialized in producing textual content, such as phrases or sentences, in response to an input prompt sentence.

The term “style specification” refers to one or more elements in a prompt sentence that define or constrain the appearance of generated visual content, including, for example, level of detail, color scheme, or illustration style.

The term “content specification” refers to one or more elements in a prompt sentence that describe the semantic or narrative aspects of the desired output, including which actions, objects, or emotions are to be visually represented.

In one embodiment, a server, a terminal, and a network cooperate to implement the claimed system. The server includes at least one processor, such as a central processing unit and optionally a graphics processing unit, and a memory storing program instructions and data structures. The terminal includes a camera, a display, an input interface, and a communication module. The user interacts with the terminal by performing gestures and facial expressions and by selecting candidate expressions and providing feedback via the display and input interface.

The terminal uses a camera module, which may be implemented by an imaging sensor in a portable information processing apparatus, a tablet-type apparatus, a wearable apparatus, or a fixed installation-type camera, to capture imaging information of the user and surrounding targets. The terminal uses an operating system camera application programming interface, such as a mobile camera capture framework, to acquire frames at a predetermined frame rate and resolution, for example, 30 frames per second at high definition. The terminal compresses the imaging information by using a hardware video encoder provided in a system-on-chip, such as an encoder for a widely used video coding standard, in order to reduce bandwidth at the transport layer. This compression reduces the amount of data transmitted to the server, which directly decreases communication load and latency compared to transmitting raw imaging information.

The terminal transmits the compressed imaging information to the server through a communication module that uses a communication line such as a wireless local area network protocol, a cellular communication protocol, or another packet-based network. The terminal establishes an encrypted channel using a secure transport protocol and maintains a session so that the server receives imaging information in near real time. The terminal also receives candidate expressions and visual information from the server and displays them using a graphics processing unit and a display driver. The terminal displays candidate expressions as text and, in some embodiments, together with icons or small images, and the terminal acquires the user's selection and evaluation through a touch panel, a pointing device, or a voice input component.

The server receives the compressed imaging information and reconstructs image frames by using a video decoding library, such as a multimedia processing framework, executed by the processor. The server converts the decoded frames into numerical tensors, for example, three-dimensional arrays of floating-point pixel values, and stores them in main memory. The server performs normalization such as converting from a device-specific color space to an internal color space and scaling pixel values into a normalized range. This preprocessing creates a consistent data representation for downstream neural network models and reduces numerical instability during inference.

The server performs object and motion recognition by using one or more neural networks implemented in a machine learning framework, such as a deep learning library. In one embodiment, the server uses a convolutional neural network or a vision transformer-type architecture as a feature extractor. The server configures the network to include multiple convolutional or attention layers, activation functions such as rectified linear units, normalization layers such as batch normalization or layer normalization, and pooling layers. The server feeds each frame tensor into this network and obtains, for each frame, feature maps and classification outputs that indicate probabilities for object classes and low-level posture states, such as “hand raised,” “cup present,” or “head turned.”

The server uses these frame-level features as input to a temporal model, such as a recurrent neural network, a long short-term memory network, a gated recurrent unit network, a temporal convolutional network, or a transformer encoder configured for sequence data. The server organizes the features into a sequence data structure, for example, a matrix with a time dimension and a feature dimension, and processes this sequence to capture temporal dependencies. The server applies attention mechanisms or recurrent operations with learned parameters to extract patterns corresponding to continuous posture changes. On this basis, the server derives a higher-level action label such as “drink from cup,” “point to door,” or “wave hello.” Because the server combines frame-level spatial features with temporal dependencies, the server improves recognition accuracy of multi-step actions compared to frame-by-frame rule-based processing and reduces false positives in ambiguous cases.

The server stores association data between recognized actions and expression information in an information storage unit, such as a relational database or a key-value store. The server uses tables or documents that map action identifiers and contextual attributes, including language type and cultural condition, to sets of candidate expressions. For example, the server may store that an action “drink from cup” under a language type corresponding to a first natural language and a cultural condition corresponding to a first region is associated with expressions such as “I want to drink” and “Shall we drink together,” while the same action under another language type and cultural condition is associated with “I want to drink coffee” and “Let's have a toast.” The server also stores user profile data, including frequently used expressions, preferred levels of formality, and preferred visual styles.

The server calculates candidate expressions by executing a search and ranking algorithm over the stored expression information. The server receives as input a recognized action identifier, user profile data, and environment information such as time of day, coarse location category, or previously selected expressions in a current session. The server forms a query data structure and executes a database search, optionally using indexing and pre-computed similarity scores, to obtain a list of matching expression records. The server then assigns priorities to these candidates by applying a ranking function. In one embodiment, the server implements the ranking function as a gradient-boosted decision tree model or as a small neural network that takes as features the action identifier, expression frequency, historical selection rate, recency of past usage, and environment attributes. The server outputs a priority score for each candidate expression and sorts the list accordingly. This learned ranking approach improves retrieval quality and reduces the number of user interactions needed to reach an appropriate expression, thereby improving overall system responsiveness and user experience.

In some embodiments, the server additionally generates expressions by using a text generative AI model. The server constructs a prompt sentence that includes the recognized action, optional object names, environment information, and user profile constraints. For example, the server may generate the following prompt sentence for a text generative AI model:

“Given that the user has performed the action ‘drink from cup’ in a home kitchen in the morning, generate 5 short, simple, polite phrases in the user's primary language that could express the user's intent.”

The server submits this prompt sentence to the text generative AI model, which may be implemented as a transformer-based language model with multiple self-attention layers and a large vocabulary embedding. The server receives generated candidate expressions, filters them based on length, complexity, and duplication criteria, and merges them with the database-derived candidates. Because the server uses a structured prompt sentence with explicit constraints and then applies a deterministic post-filtering process, the server avoids uncontrolled generation and maintains technical control over the behavior of the generative component.

The server generates visual information by using a generative AI model for images, such as a diffusion-based model with an encoder-decoder architecture. The server constructs a prompt sentence that describes both the semantic content and the visual style. For example, when the user selects an expression corresponding to drinking tea, the server may generate a prompt sentence such as:

“Generate a simple, high-contrast, comic-style illustration of a person happily drinking a hot cup of tea at a kitchen table. The image should be easy to understand for a person with communication difficulties and should clearly represent the message ‘I want to drink tea’.”

The server embeds this prompt sentence into a vector representation and inputs it, together with a noise tensor, into the generative AI model. The server executes iterative denoising steps using learned parameters of the diffusion model to produce an output image tensor. The server may use hardware accelerators such as a graphics processing unit to perform these tensor operations efficiently. The server then converts the tensor into standard image information, such as a raster image in a compressed format, and optionally post-processes the image to adjust contrast, remove artifacts, or overlay text bubbles containing the selected expression.

The server improves computational efficiency and technical performance by optimizing the processing pipeline between the terminal and the server. The server configures the recognition models so that the server can operate on downsampled frames or on feature maps instead of full-resolution frames when possible, thus reducing memory usage and computation time. The server also applies temporal subsampling and dynamic frame selection strategies, for example, skipping frames where no significant motion is detected, so as to limit processing to frames that contribute to action recognition. This configuration reduces the processing load and increases throughput, enabling real-time or near real-time responses even on general-purpose server hardware.

The server implements a feedback learning mechanism to adapt the mapping from actions to expressions and the generation of prompt sentences. The server stores interaction data, including which candidate expressions were selected and which were ignored, whether the generated visual information was rated helpful or not, and whether a communication attempt was successful according to user feedback. The server uses this interaction data as learning data to update parameters of ranking models and prompt-generation rules. In one embodiment, the server defines a loss function that penalizes rankings where highly rated candidates are placed lower and rewards prompt patterns that lead to higher user satisfaction. The server updates model weights by using gradient-based optimization, such as stochastic gradient descent or a variant, on batches of interaction data. The server may also perform data augmentation, such as adding noise to environment features or randomly masking some profile data, to improve model robustness.

Because the server explicitly models the relationship between prompt sentence structure and user feedback, the server can adjust style specification and content specification in subsequent prompt sentences. For example, if the server observes that visual information with simple backgrounds and larger character depictions consistently receives higher evaluation scores, the server modifies a portion of the prompt sentence to emphasize “simple background” and “large, clear characters.” This feedback-driven prompt optimization is not a mere automation of manual design but constitutes an adaptive algorithm that improves the behavior of the underlying generative AI model and leads to more precise and user-appropriate visual outputs over time.

The server focuses on computer-internal technical effects rather than on business-level processes. The server improves imaging information processing by performing joint spatial-temporal analysis with specialized neural network architectures and by compressing and sampling data in ways that reduce communication load while preserving recognition accuracy. The server improves data management by organizing expression information, user profiles, environment information, and interaction data in dedicated data structures that are optimized for search and ranking. The server improves computational efficiency by offloading only feature-heavy operations, such as neural network inference and diffusion model sampling, to appropriate hardware accelerators. The causality is that this particular pipeline design reduces latency, increases recognition precision, and minimizes the amount of data transmitted between the terminal and the server, which would not be possible with naive frame-by-frame processing or static rule-based mapping.

The terminal, in cooperation with the server, provides a user interface that is adapted to the technical characteristics of the recognition and generation pipeline. The terminal receives candidate expressions and codec-compressed visual information, decodes the data, and renders it in a layout where varying priority levels are reflected in visual prominence, such as font size, color intensity, or position. This layout simplifies user input and shortens interaction time, which reduces the volume of subsequent feedback data required to converge the models. The terminal also acquires evaluation inputs in structured formats, such as numerical ratings or categorical labels, which allows the server to interpret feedback as machine-processable data rather than natural language statements. This structure facilitates automated learning and supports the technical improvement of the recognition, ranking, and generation algorithms. In alternative embodiments, the server can partition functions differently. For example, the terminal can execute a lightweight object detector to identify a limited set of gestures locally and transmit only the recognized action labels and low-rate summary imaging information to the server. In this case, the server focuses on higher-level action interpretation, candidate expression ranking, prompt sentence generation, and generative model execution. This variation further reduces communication load and shifts some computation to the terminal in situations where server resources are constrained. In another variant, the server uses different network architectures, such as three-dimensional convolutional networks, for temporal modeling, or uses different generative models, such as auto-regressive visual transformers, for image generation. The overall data flow and technical effects remain similar: the server uses structured, adaptive processing to transform imaging information and interaction data into optimized linguistic and visual communication content.

The user uses the system by naturally performing gestures and facial expressions in front of the camera and by occasionally selecting candidate expressions and providing feedback on visual outputs. The user does not need to manually construct complex prompts or manually select images from large libraries. Instead, the server and the terminal cooperatively execute the described algorithms to interpret the user's actions, generate appropriate candidate expressions, construct effective prompt sentences for generative AI models, and produce visual information that enables efficient and accurate interpersonal communication. Because the system adapts over time based on accumulated learning data, the technical performance of recognition, ranking, and generation improves, resulting in reduced misinterpretation, faster response, and lower cognitive burden for the user.

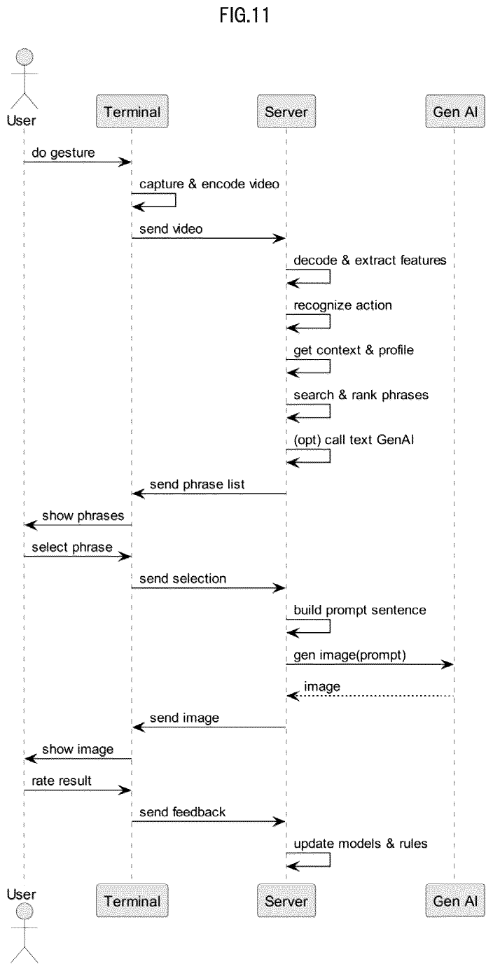

The following describes the processing flow using FIG. 11.

### Step 1:

The terminal acquires imaging information.

The terminal uses its camera to capture a sequence of image frames of the user's gestures, facial expressions, and surrounding targets at a predetermined frame rate. As input, the terminal receives analog signals from the imaging sensor and camera control parameters (exposure, focus, resolution). As processing, the terminal converts the analog signals into digital pixel arrays, applies basic image signal processing (demosaicing, white balance, denoising), and compresses the resulting frames using a video codec implemented in a system-on-chip encoder. As output, the terminal produces a compressed video stream or a series of compressed image frames ready for network transmission.

### Step 2:

The terminal transmits compressed imaging information to the server.

The terminal receives as input the compressed video stream generated in Step 1 and network configuration data such as server address and authentication tokens. As processing, the terminal segments the compressed stream into packets, attaches headers including timestamps, device identifiers, and user identifiers, and sends the packets over a secure communication protocol through a wireless or wired network interface. As output, the terminal provides the server with an ordered sequence of packets representing the compressed imaging information in near real time.

### Step 3:

The server receives and reconstructs image frames.

The server accepts as input the packetized compressed imaging information transmitted by the terminal. As processing, the server reassembles packets into a continuous compressed stream, decodes the compressed data using a video decoding library to obtain raw image frames, and converts each frame into a numerical tensor with a standardized color space and normalized pixel values. As output, the server produces a time-ordered sequence of frame tensors stored in memory for further analysis.

### Step 4:

The server extracts spatial features for each frame.

The server uses as input the sequence of frame tensors generated in Step 3. As processing, the server feeds each frame tensor into a feature extraction neural network, such as a convolutional network or a vision transformer, computes feature maps through convolution or attention operations, and applies activation and pooling functions to obtain compact feature vectors representing objects and posture states. As output, the server generates, for each frame, a set of feature vectors and preliminary labels such as “hand_raised,” “cup_present,” or “face_frowning,” each with an associated confidence score.

### Step 5:

The server performs temporal action recognition.

The server receives as input the time-ordered sequence of frame-level feature vectors from Step 4. As processing, the server groups consecutive feature vectors into fixed-length or variable-length sequences, inputs these sequences into a temporal model such as a recurrent network or temporal transformer, and computes temporal attention or recurrent updates to detect patterns of continuous posture changes. Based on these computations, the server classifies each sequence into one or more high-level actions and assigns action labels such as “drink_from_cup,” “point_to_door,” or “wave_hello,” together with start and end timestamps. As output, the server produces a list of recognized actions, each associated with temporal boundaries and confidence scores.

### Step 6:

The server enriches actions with context and user profile data.

The server takes as input the recognized actions from Step 5, plus stored user profile data and environment information such as time of day, approximate location category, and recent interaction history. As processing, the server joins action records with profile and environment tables in an information storage unit, computes context attributes (for example, “morning at home,” “frequent tea drinker”), and attaches these attributes to each action as metadata. As output, the server produces context-enriched action objects, each containing an action identifier, user profile features, and environment descriptors.

### Step 7:

The server retrieves candidate expressions from an expression database.

The server uses as input the context-enriched action objects from Step 6 and the stored expression information in a database. As processing, the server constructs database queries including action identifiers, language types, and cultural conditions, executes these queries to retrieve matching expression records, and filters the results based on language settings, length constraints, and relevance scores. As output, the server generates, for each action, an initial set of candidate expressions such as short phrases or sentences associated with the action and context.

### Step 8:

The server ranks candidate expressions using learned models.

The server takes as input the initial candidate expressions from Step 7 and interaction statistics such as historical selection rates and recency scores. As processing, the server computes feature vectors for each candidate expression (including action type, usage frequency, success rate, and environment features) and applies a ranking model, such as a gradient-boosted tree or a small neural network, to calculate a priority score for each candidate. The server sorts the candidates according to the computed scores. As output, the server produces an ordered list of candidate expressions, where higher-priority items appear earlier in the list.

### Step 9:

The server optionally expands candidates using a text generative AI model.

The server receives as input the context-enriched actions and, optionally, the top-ranked candidates from Step 8. As processing, the server generates a prompt sentence that concisely describes the recognized action, environment, and desired style of phrases, such as:

“Given that the user has performed the action ‘drink from cup’ in a home kitchen in the morning, generate 5 short, simple, polite phrases in the user's primary language that could express the user's intent.”

The server sends this prompt sentence to a text generative AI model, receives additional generated phrases, filters out unsuitable or duplicate phrases, and merges the remaining ones with the ranked candidates. As output, the server provides an updated ordered list of candidate expressions that includes both database-derived and AI-generated phrases.

### Step 10:

The server transmits candidate expressions to the terminal.

The server uses as input the ordered list of candidate expressions from Step 8 or Step 9 and identifiers for the corresponding actions and user session. As processing, the server packs the candidate expressions and related metadata (such as action IDs and priority scores) into a structured response, serializes it into a format suitable for network transmission, and sends it to the terminal via the established secure connection. As output, the server delivers candidate expression data to the terminal for user presentation.

### Step 11:

The terminal displays candidate expressions and receives a selection.

The terminal receives as input the structured candidate expression data transmitted by the server in Step 10. As processing, the terminal parses the data, generates user interface elements (buttons, tiles, or list items) for each candidate, and arranges them on the display according to the priority order (for example, placing higher-priority expressions at the top or with more emphasis). The terminal then waits for user input and records which candidate expression the user selects through touch, pointer, or voice commands. As output, the terminal produces a selection record containing the selected expression, its identifier, and a timestamp.

### Step 12:

The terminal sends the selected expression and context back to the server.

The terminal uses as input the selection record from Step 11 and any additional local context such as device status or short-term interaction history. As processing, the terminal constructs a request containing the selected expression identifier, recognized action reference, and optional flags indicating whether visual communication content should be generated. The terminal serializes this request and transmits it to the server over the existing secure connection. As output, the terminal provides the server with a structured selection message that confirms the user's chosen expression and context.

### Step 13:

The server constructs a prompt sentence for the visual generative AI model.

The server receives as input the selection message from Step 12, including the selected expression, the corresponding recognized action, and associated context metadata. As processing, the server synthesizes these inputs into a detailed prompt sentence that describes both semantic content and desired visual style, for example:

“Generate a simple, high-contrast, comic-style illustration of a person happily drinking a hot cup of tea at a kitchen table. The image should be easy to understand for a person with communication difficulties and should clearly represent the message ‘I want to drink tea’.”

The server may also modify style descriptors based on stored user preferences or previous feedback, such as adding “simple background” or “large, clear characters.” As output, the server produces a final prompt sentence ready to be supplied to a visual generative AI model.

### Step 14:

The server generates visual information using the visual generative AI model.

The server takes as input the prompt sentence from Step 13 and model configuration parameters such as image size, number of inference steps, and guidance scale. As processing, the server encodes the prompt sentence into a text embedding, initializes a noise tensor, and iteratively refines the tensor by applying the generative AI model's denoising or sampling steps on specialized hardware. The server optionally applies postprocessing filters to enhance clarity and remove artifacts. As output, the server generates image information or story-form visual information that visually represents the selected expression and action.

### Step 15:

The server transmits generated visual information to the terminal.

The server uses as input the visual information produced in Step 14 and the user session identifier. As processing, the server compresses the image or sequence of images into a standard format, stores it temporarily or in persistent storage if required, and creates a response message containing either the image data itself or a reference to its location. The server sends this response over the secure connection to the terminal. As output, the server delivers ready-to-display visual information corresponding to the user's selected expression.

### Step 16:

The terminal displays the visual information to the user.

The terminal receives as input the image data or reference transmitted from the server in Step 15. As processing, the terminal decodes the image if necessary, allocates display buffers, and renders the visual information on the screen in a layout suitable for showing to another person, optionally alongside the text of the selected expression. The terminal may also prepare controls for playback or enlargement. As output, the terminal presents a visible illustration or comic that the user can show to a communication partner.

### Step 17:

The user evaluates the candidate expression and visual information.

The user receives as input the displayed expression and visual information from Step 16. As processing, the user subjectively judges whether the content correctly expresses the intended meaning and whether the visual representation is clear and helpful. The user then performs a concrete action, such as tapping a “helpful” or “not helpful” button, selecting an alternative style preference, or skipping evaluation. As output, the user generates an evaluation input that is collected by the terminal.

### Step 18:

The terminal sends evaluation and interaction data to the server.

The terminal takes as input the user's evaluation input from Step 17, along with the selected expression identifier, prompt sentence identifier (if stored locally), and timestamps. As processing, the terminal aggregates this data into a feedback message containing evaluation labels or scores and references to the associated interaction. The terminal then transmits the feedback message to the server over the secure channel. As output, the terminal provides structured feedback data to the server for learning purposes.

### Step 19:

The server stores interaction data as learning data.

The server receives as input the feedback message from Step 18 and any related session records such as the original candidate list, the selected expression, and the prompt sentence used in Step 13. As processing, the server writes this information into one or more storage structures, including tables for candidate selection outcomes, visual evaluation results, and communication success indicators, linking them via keys such as action IDs and session IDs. As output, the server accumulates a growing dataset of learning data that associates system decisions with user responses and outcomes.

### Step 20:

The server updates models and prompt-generation rules based on learning data.

The server uses as input the stored learning data from Step 19, including historical rankings, selections, evaluations, and prompt sentence configurations. As processing, the server periodically runs training or fine-tuning procedures for ranking models and prompt-generation algorithms: it computes loss values that measure discrepancies between predicted rankings and actual user selections, adjusts model weights using gradient-based optimization, and derives rule updates that change style and content specifications in future prompt sentences. The server then deploys the updated parameters into the live processing pipeline. As output, the server produces improved models and updated rules that increase recognition accuracy, optimize candidate expression ranking, and refine prompt sentences for the generative AI model, leading to more effective and efficient subsequent interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented communication support systems that use cameras and pattern recognition suffer from several technical limitations when attempting to infer a user's intention from non-verbal behavior and convert it into suitable language and visual content. First, such systems typically employ fixed, rule-based mappings from low-level recognition results (for example, detected gestures or objects) to language outputs. This architecture leads to rigid behavior, poor adaptability to individual users, and inefficiency in updating or scaling the system, thereby limiting the precision and robustness of intent estimation and response generation.

Second, known systems generally maintain static phrase databases and manually curated candidate lists. The generation and prioritization of language candidates are often performed using simple keyword matching or hand-crafted heuristics, without dynamic interaction with advanced generative models. As a result, the system cannot efficiently adapt to different linguistic environments, cultural contexts, or evolving user preferences. From a computer-technology standpoint, this leads to suboptimal data utilization and increased maintenance cost for database updates and rule tuning.

Third, existing systems often separate recognition, language generation, and visual generation into loosely coupled components that do not exploit feedback information in a unified, machine-learning-driven loop. User and caregiver feedback, as well as success or failure of communication events, are rarely used to automatically refine both recognition parameters and candidate selection logic. Consequently, system performance stagnates over time, and computational resources are not leveraged to continuously improve the underlying models and data structures.

Fourth, conventional architectures generally do not use structured prompt sentences in a systematic way to control generative AI models for both language and image generation. When generative models are used at all, they are often invoked in an ad hoc manner, with unstructured prompts that do not incorporate rich context such as user attributes, time-series recognition results, and accumulated interaction statistics. This leads to unstable output quality, unpredictable latency, and difficulty integrating the generative model outputs into deterministic system components.

Accordingly, there is a need for an improved computer-implemented system that: (i) integrates time-series image analysis with intent estimation in a tightly coupled manner; (ii) manages and updates language information and candidate expressions using structured interaction with generative AI models via prompt sentences; (iii) uses feedback-driven learning to automatically refine both recognition parameters and candidate ranking rules; and (iv) coordinates language and visual generation processes to provide consistent, context-aware outputs. Such a system should improve the efficiency, accuracy, and adaptability of the underlying computer processes themselves, rather than merely automating a human cognitive task.

The specific processing by the specific processing unit 290 of the data processing device 12 in Application Example 1 is realized by the following means.

The present invention provides a server comprising a processor configured to acquire time-series image information including user gestures, postures, and facial expressions from an imaging device and to perform preprocessing and machine learning-based image analysis on the time-series image information to identify the gestures, postures, and facial expressions and to estimate intent information representing a user intention; to store language information in which a plurality of language expressions corresponding to the intent information are stored in association with language types and cultural attributes, and to extract, based on the intent information and user attribute information, a plurality of candidate language expressions from the language information; to generate, based on the intent information, the user attribute information, and usage history information, a first prompt sentence for use as input to a generative AI model together with the candidate language expressions, to input the first prompt sentence to the generative AI model, to obtain from the generative AI model a result for addition or modification of the candidate language expressions, and to update contents and priorities of the candidate language expressions based on the result; to cause a display unit of an information processing apparatus to present the updated candidate language expressions as selectable items arranged according to the priorities and to acquire at least one selected language expression based on an operation input applied to the selectable items; to generate, based on the selected language expression and preference information of the user, a second prompt sentence for image generation, to input the second prompt sentence to a generative AI model to obtain image information or story-format visual information, and to output the visual information as a visual communication means; and to accumulate selection results, evaluation information indicating success or failure of communication based on the visual communication means, and feedback information from the user and a communication partner, and to update at least one of the language information, the priorities of the candidate language expressions, and parameters of the intent estimation process based on the accumulated information. This enables an improved computer-implemented communication support process in which the recognition pipeline, language candidate generation, and visual content generation are dynamically optimized through structured interaction with generative AI models and feedback-driven learning, thereby enhancing system adaptability, accuracy, and processing efficiency beyond that of conventional rule-based or static-database architectures.

The term “system” refers to an integrated combination of hardware and software components that cooperate to perform image acquisition, intent estimation, language generation, visual generation, and learning processing.

The term “server” refers to an information processing apparatus including at least one processor, memory, and communication interface, configured to execute programs that implement the functions of intent estimation, language candidate management, prompt generation, interaction with generative AI models, and feedback-driven learning.

The term “processor” refers to one or more hardware computation units, such as a central processing unit or a graphics processing unit, configured to execute machine-readable instructions to carry out the operations described in the claims.

The term “imaging device” refers to an apparatus configured to capture image information of a user and surroundings, including, for example, a fixed camera, a movable camera, a camera mounted on a mobile platform, or an equivalent image sensing device.

The term “image information” refers to data representing visual scenes captured by an imaging device, including still images, video frames, and sequences of such frames arranged in time series.

The term “time-series image information” refers to a sequence of image information items ordered by acquisition time, enabling analysis of temporal changes in user gestures, postures, and facial expressions.

The term “preprocessing” refers to computational operations applied to raw image information prior to machine learning-based analysis, including, for example, decoding, resizing, normalization, noise reduction, and batching of frames.

The term “gesture” refers to a body movement of the user, including, for example, hand raising, pointing, waving, or other recognizable motion patterns.

The term “posture” refers to a spatial configuration of the user's body at a given time, including, for example, standing, sitting, lying down, or partially reclined positions.

The term “facial expression” refers to a configuration of facial features of the user indicating an emotional or physical state, including, for example, neutral, pain, discomfort, happiness, or confusion.

The term “intent information” refers to data representing an inferred intention or need of the user, derived from analysis of gestures, postures, and facial expressions, and including at least an identifier of an intent category and a confidence value.

The term “confidence value” refers to numerical information indicating a likelihood or reliability of an estimated intent, as computed by a recognition or estimation process.

The term “language information” refers to structured data in which a plurality of language expressions are stored in association with one or more intent categories, language types, cultural attributes, and additional metadata.

The term “language expression” refers to a textual representation, such as a word, phrase, or short sentence, that can be used to express a user's intent in a natural language.

The term “language type” refers to a classification of language expressions according to natural language categories, such as Japanese, English, or other human languages.

The term “cultural attribute” refers to information indicating a cultural, regional, or social context associated with a language expression, for example, a country, region, or customary communication style.

The term “user attribute information” refers to data describing properties of a user, including at least language preference, cultural background, and optionally age group, cognitive status, or other profile information used to customize system behavior.

The term “candidate language expression” refers to a language expression selected or generated as a possible representation of the user's intent, prior to final selection by a user or caregiver.

The term “usage history information” refers to data recording past interactions, including selected language expressions, associated intents, timestamps, success or failure of communication, and related feedback.

The term “prompt sentence” refers to a text sequence constructed to be input to a generative AI model, the text specifying context, constraints, and objectives so that the generative AI model can generate or modify language expressions or visual content.

The term “generative AI model” refers to a machine learning model configured to generate new data, such as text or images, in response to input data including prompt sentences, the model being trained on large-scale data and capable of producing context-aware outputs.

The term “display unit” refers to a hardware component, such as a flat-panel display or touchscreen, capable of presenting visual information including text, icons, and images to a user or caregiver.

The term “information processing apparatus” refers to an electronic device, such as a tablet, smartphone, or personal computer, that communicates with the server and presents candidate language expressions and visual information through its display unit.

The term “selectable item” refers to a visual element, such as a button or list entry on a display screen, that corresponds to a candidate language expression and can be chosen via an input operation.

The term “operation input” refers to user or caregiver actions for interacting with the system, including touch input, mouse input, keyboard input, voice input, or equivalent means for selecting items or providing feedback.

The term “preference information” refers to data indicating user-specific likes or dislikes, such as preferred colors, illustration styles, or complexity levels, used to customize generated visual information.

The term “image generation” refers to a process of creating new image information by computational means, including by using a generative AI model in response to a prompt sentence.

The term “visual information” refers to any image or combination of images, including single illustrations, icons, or multi-panel story-like sequences, that can be displayed as a visual communication means.

The term “visual communication means” refers to visual information that is generated or selected to help a user understand or confirm a represented intent, need, or message.

The term “selection result” refers to data indicating which candidate language expression or visual element was selected via an operation input in a given interaction.

The term “evaluation information” refers to data representing success or failure of communication or correctness of a selected expression or visual content, including explicit confirmations or denials and implicit assessments.

The term “feedback information” refers to information obtained from the user or a communication partner regarding satisfaction with, or appropriateness of, presented language and visual outputs, including explicit responses and inferred reactions.

The term “intent estimation process” refers to processing operations that determine intent information from input features derived from gestures, postures, and facial expressions, including model inference steps and associated parameterized computations.

The term “deep learning model” refers to a multi-layer neural network configured to process image information or derived features, such as a convolutional neural network, recurrent neural network, or transformer-based network.

The term “posture estimation model” refers to a deep learning model or equivalent algorithm configured to infer body key points, skeletons, or posture states of a user from image information.

The term “facial expression estimation model” refers to a deep learning model or equivalent algorithm configured to classify or estimate facial expressions of a user from image information.

The term “feature information” refers to numerical representations derived from image information, such as vector embeddings, key point coordinates, or other intermediate data used for recognition and intent estimation.

The term “position information” refers to data indicating a spatial location related to the user or imaging device, such as coordinates within a facility, room identifiers, or relative positions within an image.

The term “time information” refers to data representing acquisition time or temporal ordering of events, such as timestamps or relative time indices within a sequence.

The term “statistical information” refers to aggregated measures computed from usage history, selection results, or evaluation information, including counts, frequencies, probabilities, or other summary values.

The term “dialog history data” refers to structured records of past interactions between the system, the user, and communication partners, including intents, selected language expressions, visual outputs, feedback, and associated statistics.

The term “update policy” refers to information specifying how to modify language information, priorities of candidate language expressions, or processing conditions, the information being derived from generative AI model outputs or analytical processes.

The term “processing conditions for generation of the candidate language expressions” refers to parameters and rules controlling how candidate language expressions are selected, generated, filtered, or ranked based on intent information, user attributes, and feedback.

In an embodiment, a server, a terminal, and one or more imaging devices cooperate to implement the claimed system. The server includes at least one central processing unit, at least one graphics processing unit, a main memory, a nonvolatile storage device, and a network interface. The server executes programs stored in the nonvolatile storage device to perform image acquisition, machine learning-based image analysis, intent estimation, language candidate generation, interaction with a generative AI model via prompt sentences, visual information generation, and feedback-driven learning. The terminal includes a processor, a memory, a display unit such as a touchscreen, and an input interface, and executes an application program for presenting language candidates and visual information and for transmitting user and caregiver feedback to the server. The imaging device includes an image sensor, an optical system, and a communication interface, and captures time-series image information of a user and surroundings.

Server executes an operating system such as a general-purpose server operating system, and executes an application layer including a recognition module, a language information management module, a prompt management module, a generative model interface module, a visual generation module, and a learning module. Server uses a deep learning framework such as a tensor-based computation library to execute convolutional neural networks, recurrent networks, and transformer-based networks on the graphics processing unit. Server stores model parameters, language information, and interaction logs in a relational or document-oriented database.

Server receives compressed video streams from the imaging device over a packet-switched network. Server uses a multimedia library to decode compressed streams into raw frames in an RGB or BGR format. Server stores, in a frame buffer in memory, a sequence of frames together with metadata such as timestamps, camera identifiers, and environmental information. Server converts each frame to a fixed-size tensor, for example, by resizing to 224×224 pixels, normalizing pixel values, and, when necessary, converting color spaces. Server uses a pose estimation model implemented as a convolutional neural network followed by a heatmap regression layer to compute, for each frame, two-dimensional coordinates of key points representing body joints of the user. Server forms a posture feature vector by concatenating normalized joint coordinates or by projecting them into a lower-dimensional embedding space using a fully connected layer. Server uses a facial expression estimation model implemented as a convolutional neural network with multiple convolutional and pooling layers followed by a softmax output layer to classify facial regions into expression categories such as neutral, pain, discomfort, happiness, or confusion. Server crops facial regions based on detected bounding boxes and processes them through the facial expression estimation model to obtain probability distributions over expression classes.

Server associates, for each user, a time-series of posture feature vectors and facial expression probability vectors. Server batches consecutive frames into fixed-length windows and feeds the sequence of feature vectors to a temporal model, for example, a recurrent neural network such as a long short-term memory network, or a transformer-based model with multi-head self-attention. Server outputs, from the temporal model, an intent probability vector whose components correspond to predefined intent categories such as wants drink, wants toilet assistance, feels pain, or requests help. Server computes an intent identifier as the index of the maximum component of the intent probability vector and uses that component value as a confidence value. Server stores the intent identifier, the confidence value, and the associated time and user information in an intent event table in the database.

Server stores language information in a language information table. Server defines, for each language expression, a record including an expression identifier, a text string, an associated intent category, a language type, a cultural attribute, and one or more priority scores. Server stores the records in a hierarchical manner, for example, by grouping expressions by intent and by language, and by linking generic expressions and more specific variants via parent-child relations. Server also stores user attribute information, including at least a preferred language and cultural attribute, in a user profile table.

Server, upon registering new intent information, retrieves from the language information table a set of candidate language expressions whose associated intent category matches the estimated intent and whose language type and cultural attribute are compatible with the user's attributes. Server filters these candidates based on conditions such as maximum length or required politeness level and computes an initial ranking based on stored priority scores and usage statistics. Server passes this set of candidates and associated metadata to a prompt management module.

Server constructs a first prompt sentence for a language generative AI model by embedding the context of the current interaction, the estimated intent, the user attributes, and the candidate language expressions. Server concatenates, for example, a natural-language description of the situation, a list of existing candidates, and instructions for generating improved or additional expressions. An example of such a first prompt sentence is:

“An elderly non-verbal user in a Japanese care facility has been recognized, based on time-series gesture and facial expression analysis, as wanting to drink something. The following candidate phrases are stored in the language database: ‘I need a water’, ‘I need a juice’. Suggest several additional short, polite Japanese phrases that could express the user's intention to drink, suitable for display on a caregiver's tablet, and suggest which of all the phrases should be prioritized for clarity and frequency of use.”

Server sends this first prompt sentence as textual input to a generative AI model interface. Server may access a large-scale language model deployed on a separate computing resource or on the same hardware. Server receives, as output, a list of newly synthesized expressions and, optionally, recommendations regarding which expressions should be emphasized. Server parses the textual output by predefined delimiters or patterns, validates that generated expressions match the intended language type, and rejects expressions that exceed length or contain undesired content types. Server updates the language information table by inserting new records for accepted expressions and by adjusting priority scores for existing expressions based on the generative AI model's recommendations.

Server prepares a list of updated candidate language expressions for display by the terminal. Server sorts the candidates by composite priority that takes into account base priority, frequency of past successful selections in similar contexts, and the current intent confidence value. Server packs the candidate list and associated metadata into a message object and transmits it to the terminal over a secure communication channel.

Terminal receives the message and parses the candidate list. Terminal renders each candidate as a selectable item, for example, a large button with a text label and optionally an icon, on the display unit. Terminal orders the items according to the received priority, placing the most probable expression at the top. Terminal accepts user operations through the touch interface. A caregiver, acting on behalf of the user, selects one of the candidate expressions. Terminal sends a selection result message including the expression identifier, the intent identifier, the user identifier, and a timestamp to the server.

Server receives the selection result and stores it in a selection history table. Server then initiates visual communication generation. Server retrieves preference information for the user, including preferred color schemes and preferred illustration complexity levels, from the user profile table. Server constructs a second prompt sentence for an image generative AI model, combining the selected language expression, the user preferences, and the context of the interaction. An example of such a second prompt sentence is:

“Create a simple, high-contrast cartoon-style illustration for an elderly user in a care facility. The selected phrase is ‘I want water’. The scene should show the user sitting in a chair while a caregiver hands a glass of water to the user. Use clear shapes, minimal background, and soft blue tones that are easy to see for older adults.”

Server transmits this second prompt sentence to an image generative AI model via an image generation API. The image generative AI model may be implemented, for example, as a diffusion-based neural network. The model internally performs iterative denoising steps on a latent representation conditioned by the text embedding of the second prompt sentence to generate one or more images. Server receives image files, such as raster images in a standard format, and may perform post-processing, including resizing to match the display resolution of the terminal, compressing to reduce transmission size, and overlaying optional textual annotations that repeat the selected language expression.

Server associates the generated visual information with the current interaction in a visual content table and transmits the visual information to the terminal. Terminal displays the image or a sequence of images full-screen on the display unit, together with the selected language expression. A caregiver shows the display to the user and observes the user's reaction. User may nod, smile, or show another confirming gesture, or may show confusion or rejection. Terminal provides input controls for the caregiver to register explicit feedback, such as confirmation or non-confirmation. Terminal transmits this feedback, along with any additional comments, to the server.

Server treats the confirmation result as evaluation information. Server optionally performs another pass of gesture and facial expression analysis on images captured during the feedback phase to infer whether the user's implicit reaction matches the explicit feedback. Server writes, into a feedback table, a record including the selection result, the evaluation information, and context information. Server periodically aggregates these records to compute statistical information such as selection frequencies, confirmation rates, and error rates for each intent category and each candidate expression.

Server executes a learning module that uses the aggregated statistics to adjust internal parameters. Server updates priority scores in the language information table by increasing scores for expressions with high confirmation rates and decreasing scores for expressions with low confirmation rates. Server computes frequency-based weights that are incorporated into selection logic by a weighted ranking function. Server also uses confirmed interactions as labeled training data for updating the intent estimation models. Server constructs mini-batches of input feature sequences and corresponding ground-truth intent labels from past interactions. Server computes gradients of a loss function, for example, cross-entropy between predicted intent probability distributions and one-hot vectors for confirmed intents, and updates model weights in the pose, facial expression, and temporal models by backpropagation using optimization methods such as stochastic gradient descent or Adam.

Server, in some embodiments, constructs a third prompt sentence to obtain higher-level update policies from the language generative AI model. Server encodes dialog history data and statistical summaries into natural language and instructs the generative AI model to propose modifications to ranking rules or new language expressions. An example of such a third prompt sentence is:

“Consider the following recent interaction statistics for a non-verbal elderly user: when the intent ‘wants drink’ is inferred with high confidence, the phrase ‘I need a water’ is selected and confirmed in 80% of cases, while ‘I want to drink a tea’ is confirmed in 10% and ‘I need a juice’ in 5%. Based on these statistics, suggest how to adjust the priority ordering of these phrases and propose up to three additional phrases that might cover common but currently unaddressed needs. Provide reasoning for your recommendations.”

Server receives text describing an update policy and applies rules to translate the policy into numeric changes to priority scores or into new records in the language information table. Server may apply such updates automatically or may require an administrator's approval. Server, by using generative AI models via structured prompt sentences and by maintaining specific data structures (intents table, language information table, selection history table, visual content table, and feedback table), performs processing that goes beyond mere automation of human decisions. Server improves computational efficiency by limiting calls to generative AI models to compact prompt sentences that aggregate only relevant context, thus reducing communication bandwidth and processing overhead. Server improves recognition accuracy by using feedback-driven retraining, thereby lowering error rates in intent estimation as the system collects more data. Server improves data management by storing and organizing language expressions and priorities in a normalized database schema that enables rapid query and update operations.

Server, in another embodiment, uses different neural network architectures to accommodate devices with different resources. For example, server may use a residual network with fewer layers or a MobileNet-like architecture for pose estimation when computational resources are limited. Server may use quantized weights to reduce memory consumption and increase inference speed. Server may also apply data augmentation techniques, such as random cropping, flipping, brightness adjustment, or synthetic gesture composition, when training models, to improve robustness to variations in lighting, camera angle, and user appearance. Server, in yet another embodiment, applies non-conventional processing rules to combine recognition outputs and language candidates. Server does not simply map each gesture to a fixed phrase but uses a hybrid rule set that considers confidence thresholds, co-occurring expressions, temporal patterns, and user-specific habits. For example, server may treat a combination of a raised hand and a grimace as a distinct pattern with a specialized intent probability distribution rather than as a linear combination of two independent gestures. Server may define a decision rule that, if an intent confidence surpasses a predefined threshold and the same intent was recently confirmed, the system bypasses lower-priority expressions and presents a minimal set of candidates to reduce caregiver cognitive load and interface latency. This rule-based selection is distinct from simple human reasoning and is implemented as a deterministic algorithm using thresholds, time windows, and per-user state variables.

Terminal, by receiving only a ranked subset of candidate expressions and compressed visual content, reduces its own computational burden and allows responsive interactions even on resource-constrained devices. Terminal need not execute complex recognition models; instead, terminal focuses on user interface rendering and simple event capture. This separation of roles contributes to overall system responsiveness, as heavy computations occur on the server where dedicated processing units and optimization libraries are available.

User interacts with the system mainly through natural behavior and simple confirmations, rather than through explicit configuration or training operations. User does not need to understand the internal models. Nevertheless, the system exploits the user's implicit signals to refine its technical behavior. Over time, the system's technical performance metrics, including classification accuracy for intents, average response time for candidate presentation, and network load for image and model interactions, improve due to the described learning and optimization mechanisms.

In summary, server applies specific deep learning architectures, database structures, prompt construction techniques, and feedback-driven adaptation rules to achieve technical effects such as increased intent estimation accuracy, reduced processing and communication overhead, robust adaptation to user-specific patterns, and efficient integration of generative AI models into a deterministic processing pipeline. These improvements arise from concrete computational procedures and data structures implemented in hardware and software, and therefore constitute enhancements to computer technology itself rather than an abstract automation of human cognitive tasks.

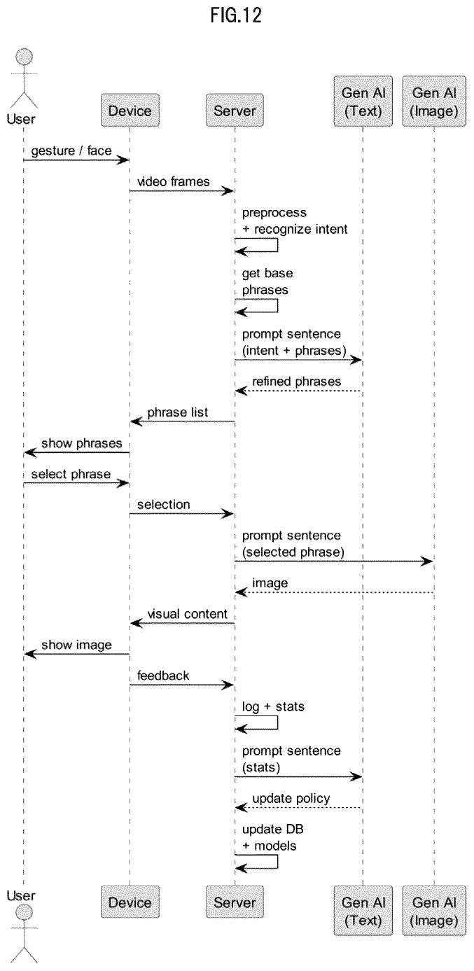

The following describes the processing flow using FIG. 12.

### Step 1:

Server receives raw image data from the imaging device.

Server uses a network interface to accept a continuous stream of compressed video packets (input) from the imaging device, each packet including encoded frames and metadata such as camera ID and timestamp.

Server applies a multimedia decoding library to convert the compressed stream into a sequence of raw image frames (output), each represented as a two-dimensional array of pixel values and associated metadata records.

User performs natural behaviors such as raising a hand, pointing, or changing facial expression, which cause corresponding visual changes in the input frames captured by the imaging device.

### Step 2:

Server preprocesses the raw image frames to generate normalized tensors for recognition.

Server takes the sequence of raw frames and metadata (input) and for each frame performs resizing to a fixed resolution, color space conversion, and pixel value normalization.

Server stacks multiple consecutive frames into a time window, converts each frame to a numeric tensor, and stores the resulting tensor batch (output) in a frame buffer for later machine learning-based analysis.

Server records the association between each tensor batch and a user identifier, a camera identifier, and time information in a frame index table.

### Step 3:

Server extracts posture features using a pose estimation model.

Server reads a tensor batch for one time window (input) and feeds each frame tensor to a convolutional neural network trained for human pose estimation.

Server computes, for each frame, heatmaps for body joint locations, applies an argmax operation or soft-argmax to estimate coordinates of key points, and normalizes the coordinates relative to frame size.

Server concatenates the normalized key points into a posture feature vector and stores, for each frame, a time-stamped posture feature sequence (output) associated with the user.

### Step 4:

Server classifies facial expressions from cropped facial regions.

Server uses bounding box information or a face-detection model to crop facial regions from the preprocessed frames (input).

Server feeds each cropped facial image to a convolutional neural network configured for facial expression classification, computes a probability distribution over predefined expression classes, and selects a top-ranked expression label along with its probability.

Server outputs, for each frame, a facial expression feature vector and an expression label, and stores these in a facial expression feature sequence aligned with the posture feature sequence.

### Step 5:

Server aggregates posture and facial expression features over time to estimate user intent.

Server takes synchronized posture feature vectors and facial expression vectors for a fixed time window (input) and concatenates them into combined feature vectors per frame.

Server feeds the sequence of combined feature vectors to a temporal model, such as a recurrent neural network or transformer, and computes an intent probability vector at the end of the sequence.

Server selects the intent identifier corresponding to the highest probability and uses that probability as a confidence value, producing an intent record (output) that includes user ID, time, intent identifier, and confidence.

### Step 6:

Server retrieves base candidate language expressions from the language information table.

Server uses the intent identifier and user attribute information (input) to issue a database query that selects language expressions associated with the intent and matching the user's language type and cultural attribute.

Server filters the query results based on length, politeness level, or category flags, and computes initial priority scores from stored priority fields and usage frequencies.

Server outputs a set of base candidate language expressions with associated metadata, including expression IDs, text strings, language types, cultural attributes, and initial priority scores.

### Step 7:

Server constructs a first prompt sentence and invokes a language generative AI model to refine candidate expressions.

Server takes the base candidate language expressions, intent record, and user attributes (input) and constructs a structured natural-language description that includes situation context, existing candidates, and instructions.

Server creates a first prompt sentence, for example:

“An elderly non-verbal user in a Japanese care facility has been recognized, based on time-series gesture and facial expression analysis, as wanting to drink something. The following candidate phrases are stored in the language database: ‘I need a water’, ‘I want to drink a tea’, ‘I want to drink a juice’. Suggest several additional short, polite Japanese phrases that could express the user's intention to drink, suitable for display on a caregiver's tablet, and suggest which of all the phrases should be prioritized for clarity and frequency of use.”

Server sends this first prompt sentence as text to a language generative AI model and receives a text output containing additional expressions and priority recommendations (output).

### Step 8:

Server parses and updates the candidate language expression set based on the generative AI model output.

Server takes the first prompt response (input) and splits the text into individual expression candidates and any associated ranking hints, using predefined parsing rules or pattern matching.

Server validates each new expression by checking language type, maximum length, and forbidden patterns, and discards invalid entries.

Server inserts valid new expressions into the language information table and recalculates priority scores for both existing and new expressions, resulting in an updated candidate set (output) that includes text, expression IDs, and refined priorities.

### Step 9:

Server sends the updated candidate language expressions to the terminal for presentation.

Server takes the updated candidate set and the intent record (input) and creates a message object that lists candidate expressions in priority order, along with identifiers and optional icon types.

Server serializes the message object and transmits it to the terminal through a secure communication channel.

Server outputs a transmitted candidate list, which the terminal will parse and display.

### Step 10:

Terminal displays candidate language expressions and accepts caregiver selection.

Terminal receives the candidate list message (input) and decodes it into an internal data structure containing text labels and associated IDs.

Terminal draws a user interface on the display unit, creating selectable items such as buttons for each candidate expression, arranged in descending priority.

Terminal captures a touch event or equivalent input when the caregiver selects one candidate and creates a selection result (output) containing the selected expression ID, intent ID, user ID, and a timestamp.

### Step 11:

Server records the selection result and prepares for visual communication generation.

Server receives the selection result from the terminal (input) and stores it in a selection history table together with the corresponding intent record.

Server retrieves user preference information from the user profile table and combines it with the selected expression and context information.

Server generates a visual context object (output) that includes the selected phrase text, user preferences, and environment information for use in image generation.

### Step 12:

Server constructs a second prompt sentence and invokes an image generative AI model to generate visual information.

Server uses the visual context object (input) to create a second prompt sentence that describes the desired illustration or story-like sequence.

Server constructs, for example, the following second prompt sentence:

“Create a simple, high-contrast cartoon-style illustration for an elderly user in a care facility. The selected phrase is ‘I need a water’. The scene should show the user sitting in a chair while a caregiver hands a glass of water to the user. Use clear shapes, minimal background, and soft blue tones that are easy to see for older adults.”

Server sends the second prompt sentence to an image generative AI model, which returns one or more generated images (output) in a predetermined image format.

### Step 13:

Server post-processes generated images and associates them with the interaction.

Server takes the generated images (input) and performs image processing operations such as resizing to match the terminal's resolution, compressing to reduce file size, and optionally overlaying the selected phrase as a caption.

Server stores the processed images in a visual content table and links them to the selection result and intent record by identifiers.

Server produces ready-to-display visual content (output) with references for retrieval by the terminal.

### Step 14:

Server sends the visual content to the terminal for presentation to the user.

Server retrieves the processed images and associated metadata (input) and packages them into a visual content message addressed to the terminal.

Server transmits the visual content message across the network, ensuring that the terminal can obtain URLs or binary payloads for each image.

Server outputs sent visual content data that the terminal will render.

### Step 15:

Terminal displays visual content and captures feedback.

Terminal receives the visual content message (input) and loads the image data into its graphics subsystem.

Terminal displays the image or image sequence full-screen, together with the selected language expression text, and allows the caregiver to present the display to the user.

Terminal provides feedback controls such as “User confirmed” or “User did not confirm” and captures caregiver input, producing feedback information (output) containing a confirmation flag, optional comments, and timestamps.

### Step 16:

User provides implicit feedback through gestures or expressions.

User views the visual content on the terminal display (input) and reacts naturally, for example by nodding, smiling, or showing confusion.

User's reaction changes gestures, postures, and facial expressions in the physical environment, which are captured as new image data by the imaging device.

User's implicit feedback becomes part of subsequent raw image data (output) that will be analyzed by the server in the same recognition pipeline.

### Step 17:

Server records feedback information and updates interaction logs.

Server receives explicit feedback from the terminal and captures implicit feedback from newly acquired frames (input).

Server runs the recognition models on the new frames to infer whether the user's gestures or facial expressions indicate confirmation or rejection, and combines this inference with explicit caregiver feedback.

Server stores the combined evaluation results in a feedback table as log entries (output) linked to the related selection result, visual content, and intent record.

### Step 18:

Server aggregates historical data and computes statistical information.

Server reads selection history records and feedback records accumulated over a defined period (input) and groups them by user, intent, and language expression.

Server calculates, for each expression and intent, statistics such as selection count, confirmation rate, and error count, and stores these statistics in a summary table (output).

Server also derives temporal patterns, such as trends in phrase success rate over time, for use in subsequent learning and optimization.

### Step 19:

Server updates language expression priorities and retrains intent estimation models based on feedback.

Server takes the statistical summary data (input) and applies update rules that increase priority scores for expressions with high confirmation rates and decrease scores for expressions with low confirmation rates.

Server writes updated priority values back to the language information table and selects confirmed intent events as labeled training examples.

Server uses these examples to compute gradients of a loss function for the pose, facial expression, and temporal models, updates model weights with an optimization algorithm, and outputs refined model parameters and updated language priorities (output) that will be used in future recognition and candidate generation.

### Step 20:

Server optionally constructs a third prompt sentence to obtain update policies from the language generative AI model.

Server takes dialog history data and statistical information for a user or intent category (input) and encodes them into a narrative description of past outcomes.

Server constructs a third prompt sentence, for example:

“Consider the following recent interaction statistics for a non-verbal elderly user: when the intent ‘I want to drink’ is inferred with high confidence, the phrase ‘I need a water’ is selected and confirmed in 80% of cases, while ‘I want to drink a tea’ is confirmed in 10% and ‘I need a juice’ in 5%. Based on these statistics, suggest how to adjust the priority ordering of these phrases and propose up to three additional phrases that might cover common but currently unaddressed needs. Provide reasoning for your recommendations.”

Server sends this third prompt sentence to the language generative AI model and receives a text describing update policies (output), which will guide further adjustments to database entries and processing conditions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional communication support systems for users with language impairments typically rely on fixed symbol boards, static phrase lists, or simple mapping from recognized objects to predefined sentences. Such systems often suffer from several technical limitations in terms of computer technology.

First, conventional systems generally treat image recognition and emotion estimation as independent or simplistic processes, or they omit emotion estimation entirely. As a result, the processing pipeline cannot jointly leverage multimodal inputs such as camera images, audio signals, and interaction logs to compute a fine-grained emotional state. The computer therefore cannot dynamically adapt its candidate selection algorithm or user interface control parameters based on real-time changes in user tension, confusion, or affect. This leads to sub-optimal utilization of computational resources and poor responsiveness of the human-machine interface.

Second, many existing systems do not perform integrated control of a language expression database, a candidate ranking mechanism, and a user interface layout engine. Typically, the server or device retrieves static phrases by simple key-value matching and presents them in a fixed layout, without using machine learning-based scoring that takes into account per-user selection histories, usage frequencies, and recognized emotional states. In such architectures, the processor does not exploit prior session logs as training data to adjust scoring parameters, nor does it automatically optimize the user interface for users under cognitive or emotional load. This results in inefficient presentation of options, unnecessary user interactions, and increased latency in finding appropriate expressions.

Third, while generative artificial intelligence models have become available for natural language and image generation, conventional assistive communication systems either do not integrate such models at all, or integrate them in an ad-hoc manner that is not deeply coupled with recognition outputs and user feedback. In many cases, a generative AI model is invoked with manually crafted prompts that do not reflect structured recognition results (such as specific actions, objects, and emotional intensities) and are not updated based on historical success or failure of communications. Consequently, the computing system does not fully exploit the generative capabilities to produce context-appropriate candidate phrases or visual content, and cannot systematically improve prompt quality over time.

Fourth, prior systems typically lack an architecture in which a processor centrally coordinates recognition units, database access, user interface adaptation, prompt construction, generative AI inference, and learning. Without such coordination, each component operates with local heuristics, leading to redundant computations, fragmented state management, and difficulty in scaling or customizing the system per user. This limitation constitutes a technical problem in the design and implementation of computer-implemented communication support systems that must process heterogeneous data streams and generative outputs in real time.

Accordingly, there is a need for an improved computer-implemented system and server architecture that: (i) jointly processes multimodal input data to infer actions, objects, and emotional states; (ii) dynamically generates and ranks language expression candidates using structured attributes and per-user histories; (iii) constructs and refines prompt sentences for generative AI models to generate both additional linguistic candidates and visual content; and (iv) performs continual machine learning-based updates of scoring parameters, user interface control parameters, and prompt construction rules, such that the overall computing system becomes more adaptive, efficient, and effective in supporting communication for users with language impairments.

The specific processing by the specific processing unit 290 of the data processing device 12 in Example 2 is realized by the following means.

The present invention provides a server comprising a processor configured to acquire, via an imaging unit, image information including at least a user's gesture, facial expression, and surrounding object; to identify, via a first recognition unit, a user action or activity and an object based on the image information; to estimate, via a second recognition unit, an emotional state of the user based on at least a part of the image information, acoustic information, and operation history information; to store, in a language database unit, language expression candidates in a plurality of languages in association with the identified action or activity, the identified object, and the estimated emotional state, together with attribute information including at least an action attribute, an object attribute, an emotional attribute, and a usage frequency attribute; to generate, via a candidate generation unit, a plurality of language expression candidates by querying the language database unit on the basis of outputs of the first recognition unit and the second recognition unit and by scoring and prioritizing the language expression candidates according to at least a degree of match with the action, a degree of match with the emotional state, a general usage frequency, and a user-specific usage frequency; to generate user interface control information, via a candidate presentation unit, including at least a display count, a character size, spacing between display elements, and a background style on the basis of the generated language expression candidates and the estimated emotional state, to present the language expression candidates together with the user interface control information to the user, and to obtain a selection operation by the user with respect to at least one of the language expression candidates; to construct, via a prompt generation unit, a prompt sentence for generation that includes at least a selected language expression, the estimated emotional state, and instructions regarding at least a character expression, a character action, a background, a color tone, and a style, on the basis of the selected language expression, the emotional state, and user attribute information and preference information; to input the constructed prompt sentence for generation into a generative artificial intelligence model and, via a visual content generation unit, to generate visual content including at least an illustration-type image or a comic-type image and output the visual content as a visual communication means for intention transmission by the user; and to update, via a learning unit using a machine learning algorithm, at least a scoring parameter used in the candidate generation unit, a user interface control parameter used in the candidate presentation unit, and a rule for constructing the prompt sentence for generation used in the prompt generation unit, on the basis of at least one of a presentation history of the language expression candidates, a selection history by the user, a usage situation of the visual content, and information related to the emotional state. This enables the computing system to technically improve its operation by adaptively integrating multimodal recognition, candidate ranking, user interface control, and generative AI prompt construction, thereby reducing computational waste, optimizing user interface behavior for users under varying emotional states, and progressively enhancing the relevance and effectiveness of generated linguistic and visual communication content through data-driven updates of internal parameters and rules.

The term “imaging unit” refers to a hardware and software combination configured to capture image information including at least a user's gesture, facial expression, and surrounding object, and to output digital image data to the processor.

The term “image information” refers to digital data representing one or more images or frames captured by the imaging unit, including pixel values sufficient to analyze a user's gesture, facial expression, and surrounding object.

The term “first recognition unit” refers to a functional unit implemented by the processor and executable programs, configured to receive image information and to identify at least one user action or activity and at least one object based on analysis of the image information.

The term “second recognition unit” refers to a functional unit implemented by the processor and executable programs, configured to estimate an emotional state of the user based on at least a part of the image information, acoustic information, and operation history information.

The term “acoustic information” refers to digital audio data acquired from a sound capturing device, including at least a user's speech or vocalization, and represented as a waveform, spectral representation, or acoustic feature vector.

The term “operation history information” refers to digital records of user interactions with an interface device, including at least timestamps, event types, positions, and sequences of input operations such as touches, clicks, or gestures.

The term “emotional state” refers to information representing a psychological condition of the user, including at least one of a categorical label such as joy, sadness, anger, anxiety, surprise, or neutral, and a continuous value or score indicating intensity of such condition.

The term “language database unit” refers to a data storage structure and associated management logic configured to store, retrieve, and update language expression candidates and associated attribute information in one or more languages.

The term “language expression candidate” refers to a textual unit such as a phrase, sentence, or short utterance that is stored in the language database unit and is usable to express an intention of the user to another person.

The term “action attribute” refers to attribute information associated with a language expression candidate, indicating one or more actions or activities, such as drinking, pointing, requesting, or greeting, that the candidate is suitable to express.

The term “object attribute” refers to attribute information associated with a language expression candidate, indicating at least one physical or conceptual object, such as a cup or a tool, that is relevant to the meaning or use of the candidate.

The term “emotional attribute” refers to attribute information associated with a language expression candidate, indicating at least one emotional context or nuance, such as joy, anxiety, politeness, or urgency, for which the candidate is appropriate.

The term “usage frequency attribute” refers to attribute information associated with a language expression candidate, indicating a frequency or likelihood of the candidate being used, and including at least one of a global usage frequency and a user-specific usage frequency.

The term “candidate generation unit” refers to a functional unit implemented by the processor and executable programs, configured to query the language database unit based on outputs of the first recognition unit and the second recognition unit, and to generate a plurality of language expression candidates by scoring and prioritizing the candidates according to predetermined criteria.

The term “scoring parameter” refers to a numerical parameter used by the candidate generation unit in computing scores for language expression candidates, the parameter influencing contributions of at least action match, emotional state match, general usage frequency, and user-specific usage frequency.

The term “candidate presentation unit” refers to a functional unit implemented by the processor and executable programs, configured to generate user interface control information, to present language expression candidates to the user according to the control information, and to obtain a selection operation by the user.

The term “user interface control information” refers to data defining presentation characteristics of a user interface, including at least a display count of candidates, a character size, a spacing between display elements, and a background style.

The term “prompt generation unit” refers to a functional unit implemented by the processor and executable programs, configured to construct a prompt sentence for generation, the prompt sentence describing at least a selected language expression, an emotional state, and visual elements such as character expression, character action, background, color tone, and style.

The term “prompt sentence for generation” refers to a text instruction configured as input to a generative artificial intelligence model, the instruction specifying conditions and constraints for generating additional language expressions or visual content.

The term “generative artificial intelligence model” refers to a machine learning model configured to generate new data, including at least textual or visual data, in response to an input prompt sentence for generation, and including models such as language models and image generation models.

The term “visual content generation unit” refers to a functional unit implemented by the processor and executable programs, configured to input the prompt sentence for generation into the generative artificial intelligence model, to obtain generated visual content, and to output the visual content for presentation to the user.

The term “visual content” refers to digital image data generated by the visual content generation unit using the generative artificial intelligence model, including at least an illustration-type image or a comic-type image usable as a visual communication means.

The term “visual communication means” refers to a form of communication in which the user conveys an intention or emotional nuance to another person by presenting visual content generated by the system.

The term “learning unit” refers to a functional unit implemented by the processor and executable programs, configured to update at least scoring parameters, user interface control parameters, and rules for constructing the prompt sentence for generation, by applying a machine learning algorithm to historical data.

The term “machine learning algorithm” refers to a computational procedure that adjusts internal parameters or rules based on training data, including at least supervised learning, unsupervised learning, or reinforcement learning methods.

The term “user interface control parameter” refers to a configurable value used by the candidate presentation unit to determine aspects of the user interface, including at least the display count of candidates, the character size, and the spacing between display elements.

The term “presentation history” refers to stored information indicating which language expression candidates were presented to the user, in which order, and with which associated control parameters, during one or more sessions.

The term “selection history” refers to stored information indicating which language expression candidates were selected by the user, and when and under which conditions the selections occurred.

The term “usage situation of the visual content” refers to information indicating how the generated visual content was used or viewed, including at least display duration, user actions following display, or instances of regeneration.

The term “user attribute information” refers to data describing characteristics of a user, including at least a language setting, a regional setting, demographic information, or other profile information used to customize system behavior.

The term “preference information” refers to data describing preferences of a user regarding content or interface, including at least a preferred visual style, color scheme, or complexity of language expressions.

The term “tension level” refers to a quantitative measure computed from multimodal data, indicating a degree of nervousness or stress of the user, used by the system to adjust candidate presentation and interface behavior.

The term “confusion level” refers to a quantitative measure computed from multimodal data, indicating a degree of uncertainty or disorientation of the user, used by the system to adapt interface layout and candidate complexity.

In one embodiment, a server, a terminal, and a user cooperate to implement the claimed system. The server includes at least one central processing unit, a main memory, a non-volatile storage device, and a network interface, and executes operating system software and application software on this hardware. The terminal includes at least one processing unit, a camera, a microphone, a display, an input device, and a wireless communication module, and executes a dedicated client application. The user operates the terminal to perform gestures and selections.

Server executes an imaging unit function by controlling the terminal camera via a network protocol and by processing image data received from the terminal. Terminal uses an operating system camera framework, such as a mobile camera application programming interface, to capture image information including the user's gesture, facial expression, and surrounding object. Terminal compresses the captured image into a digital format, such as a compressed still image format, and transmits the image information to the server through a secure communication channel. Server stores the received image information in a structured buffer in main memory for subsequent processing.

Server implements the first recognition unit as an execution of one or more trained neural networks using a deep learning framework, such as a tensor computation framework, on a graphics processing accelerator. Server converts the image information into a tensor, normalizes pixel values, and inputs the tensor into an object detection model, for example a convolutional neural network having multiple convolutional layers, batch normalization layers, and non-linear activation functions, followed by detection heads for predicting bounding boxes and object classes. Server computes, for each frame, object labels and bounding boxes, assigns confidence scores, and discards detections below a threshold. Server further stacks a plurality of consecutive frames in temporal order and inputs this stack into an action recognition network, for example a three-dimensional convolutional neural network or a transformer-based sequence model, which computes an action probability distribution over a predefined action set. Server outputs the label of a user action or activity, such as “lift”, “point”, or “drink”, as the first recognition result. By grouping object and action labels in time, server applies rule-based logic or a secondary classifier to infer a higher-level action, such as “drink from a cup”.

Server implements the second recognition unit as a multimodal emotion estimation pipeline. Server detects a face region in the image information using a face detection neural network and crops the detected region. Server resizes the cropped region and inputs it into a facial emotion recognition network, for example a convolutional neural network trained on labeled facial expression datasets. Server computes a probability distribution over emotional categories, such as joy, sadness, anger, anxiety, surprise, and neutral. Server processes acoustic information received from terminal by decoding compressed audio and computing acoustic features, such as spectral coefficients, pitch, energy, and temporal derivatives, using a signal processing library. Server inputs these feature vectors into a recurrent or transformer-based speech emotion recognition network to obtain another probability distribution over emotional categories. Server processes operation history information, including time-stamped touch events and error events, by computing statistics such as average inter-tap interval, frequency of rapid taps, and rate of mis-taps. Server inputs these statistics into a lightweight classifier to estimate scalar values representing a tension level and a confusion level.

Server fuses the outputs of the facial, acoustic, and interaction-based models using a multimodal fusion network implemented as a neural sequence model with an attention mechanism. Server concatenates or otherwise combines feature vectors, applies learned attention weights to each modality, and outputs a fused emotional state, including a dominant emotion label and continuous intensity scores. By using attention-based fusion instead of simple voting, server improves robustness to noisy or missing modalities, which is a technical improvement over conventional unimodal recognition and reduces computation wasted on unreliable inputs.

Server implements the language database unit as a set of relational tables in a database management system or as documents in a structured data store. Server defines, for each language expression candidate, fields that store a text string, associated action attribute, object attribute, emotional attribute, language code, region code, global usage frequency, and user-specific usage statistics. Server creates indexes on at least action, object, and emotion fields so that queries based on recognition results can be executed efficiently. This structure enables rapid retrieval and update of candidates, reducing latency and improving scalability when many users are served concurrently.

Server implements the candidate generation unit as a program that formulates queries, computes scores, and ranks candidates. Server receives the output of the first recognition unit (action and object labels) and the second recognition unit (emotional state) and issues a parameterized query to the language database unit to obtain a first set of candidate records. Server then computes, for each candidate, a score according to a formula that combines an action match component, an emotion match component, a global frequency component, and a user-specific frequency component, each weighted by a scoring parameter. Server normalizes scores and sorts candidates to form a ranked list. By encoding user-specific frequency as a weighted component, server can adapt candidate selection over time, reducing the number of steps the user needs to reach frequently used expressions, and thereby increasing interaction efficiency.

Server further configures the candidate generation unit to interact with a generative AI model in some embodiments. Server constructs a prompt sentence that describes the recognized action, object, and emotional state, including constraints on language, tone, and length. For example, server may generate the following prompt sentence and send it to a generative AI language model:

The user is lifting a cup to drink and the detected emotion is “joy”. Assume a friendly conversation with friends. Generate 5 short Japanese phrases that express a fun, cheerful toast. Return only the phrases, one per line, without additional explanation.

Server receives generated phrases from the generative AI model, splits them into individual candidates, and filters out duplicates or phrases that do not meet basic criteria. Server then merges these generated candidates with database-retrieved candidates and re-applies scoring and ranking. In this way, server augments a fixed database with dynamic generation while maintaining control through structured scoring, improving coverage without unbounded growth of stored phrases.

Server implements the candidate presentation unit by generating user interface control information and transmitting it to terminal. Server computes a display count, a character size, element spacing, and a background style as user interface control parameters based on the emotional state, the tension level, and the confusion level, along with system defaults. For example, if the tension level is high, server sets a small display count, large character size, and wide spacing, reducing visual complexity and minimizing touch errors. Server packages the ranked list of candidates with these parameters and sends them to terminal.

Terminal receives the user interface control information and candidate list, and uses a graphical user interface framework to render the candidates as interactive elements, such as large touch buttons. Terminal displays the text of each language expression candidate using the specified character size and spacing against a background following the specified style. If the user has difficulty reading, terminal may also invoke a text-to-speech engine to vocalize the candidates. User inspects the displayed options and selects at least one candidate expression by touching the corresponding element. Terminal records the identifier of the selected candidate, the text, and the selection time, and sends this information back to server. Server implements the prompt generation unit as a program that constructs a detailed prompt sentence for the generative AI model responsible for visual content generation. Server retrieves the selected language expression, the emotional state, and profile information, such as a preferred illustration style, and then composes a textual description of a scene that reflects these inputs. Server specifies elements such as the number of characters, their facial expressions, their actions, objects in the scene, lighting, color tone, background, and graphic style. For example, server may construct the following prompt sentence:

The user has selected the phrase “Let's toast together!” and the emotion is “joy”. Generate a bright, manga-style illustration where several smiling people are clinking their glasses in a toast. Use vivid colors and show a simple party venue in the background.

In another example, server may construct:

The user has selected the phrase “Please give me some water” and the emotion is “anxiety”.

Generate an illustration in calm colors where a person who looks unwell is anxiously reaching for a glass of water, while another person gently offers the glass.

Server then inputs the constructed prompt sentence into a generative AI image model that is implemented as a diffusion-based generative model or other neural image synthesis model. Server uses a deep learning framework to encode the prompt into an embedding and runs a guided sampling process to generate a visual content tensor. By tightly coupling prompt construction to recognized actions and emotions, server enables the generative model to produce images that more accurately represent the user's situation, thus reducing the number of regeneration attempts and network traffic.

Server implements the visual content generation unit by wrapping the generative AI model inference with pre-processing and post-processing. Server sets model parameters such as guidance scale, number of diffusion steps, and resolution based on system configuration. After generating an image tensor, server applies image processing operations, such as contrast adjustment, color balancing, and resizing, using an image processing library, and encodes the final image into a format suitable for terminal display. Server then transmits the encoded visual content to terminal. Terminal decodes the image and renders it on the display, optionally along with the associated text expression. User can present the visual content directly to another person as a visual communication means, which is particularly valuable for users who cannot easily produce speech.

Server implements the learning unit as a background process that periodically updates internal parameters using a machine learning algorithm. Server logs, in structured records, the presentation history of candidates, including candidate identifiers, ranking positions, user interface control parameters, and timestamps; the selection history, including which candidates were chosen and under what recognized states; and the usage situation of visual content, such as display duration and whether the user requested a different expression or image. Server uses these records as training data to adjust scoring parameters in the candidate generation unit, user interface control parameters in the candidate presentation unit, and rules for constructing prompt sentences in the prompt generation unit.

Server may implement the learning algorithm as a supervised learning method. For example, server defines an objective function that rewards candidates that were frequently selected and penalizes candidates that were never selected, under similar recognition conditions. Server computes gradients of this objective with respect to scoring parameters and updates the parameters using an optimization procedure. For user interface control, server may estimate mappings from tension level and confusion level to optimal display counts and font sizes that minimize mis-taps and selection times. For prompt construction, server may analyze pairs of recognition context and prompt sentences that led to successful communication, and adjust rules to emphasize certain attributes, such as emotional descriptors or object mentions, that correlate with higher user satisfaction.

By structuring data flows through defined units and by updating parameters based on empirical outcomes, server improves the precision of candidate selection, shortens the time to find appropriate expressions, reduces mis-operations, and reduces unnecessary invocations of the generative AI model, which collectively reduce computational load and network usage. The system therefore does not merely automate human choice of phrases, but modifies internal computer operations to optimize inference, data access, and interface rendering.

Server may implement multiple alternative embodiments for the generative AI model. In one embodiment, server uses a text-only generative AI model solely for phrase generation, and a separate image generation model for visual content. In another embodiment, server uses a unified multimodal generative AI model that can both expand phrases and generate images from a shared embedding space. In some embodiments, server executes the generative AI model locally on its own accelerators; in other embodiments, server invokes a remote generative AI service over a network, transmitting only compact prompt sentences and receiving compressed images, which reduces terminal-side resource requirements and maintains user privacy by avoiding transmission of raw image frames beyond initial recognition.

Server may also employ different neural network architectures for recognition. For example, the first recognition unit may use a vision transformer architecture instead of a convolutional network, and the second recognition unit may use a multimodal transformer that treats visual, acoustic, and interaction features as tokens. Training of these models may be performed offline using large, labeled datasets, where loss functions such as cross-entropy for classification and mean squared error for intensity estimation are minimized. Data augmentation techniques, such as random cropping, flipping, time warping, and noise injection, may be used during training to improve robustness. Although training is typically executed before deployment, server may perform incremental fine-tuning on anonymized interaction logs in a controlled manner to adapt models to a particular deployment environment.

In addition, server may implement rule-based fallbacks for cases where neural model confidence is low, such as defaulting to a small, fixed set of safe expressions or limiting the use of generative AI models when network conditions are poor. This combination of learned and rule-based processing ensures that the system maintains predictable behavior and stable performance in a variety of conditions.

In all embodiments, the cooperation between server, terminal, and user is oriented toward improving computer-implemented processes rather than merely replicating human decision-making. By integrating multimodal recognition, structured database retrieval, adaptive interface control, detailed prompt sentence generation, and feedback-driven learning, the system improves processing accuracy, response time, and resource utilization in a way that is specific to computer technology. The architecture, data structures, and algorithms enable the processor to perform operations that a human could not practically execute in real time, such as high-dimensional feature extraction, probabilistic fusion across modalities, and dynamic optimization of interface layout and generative AI behavior based on thousands of past interactions.

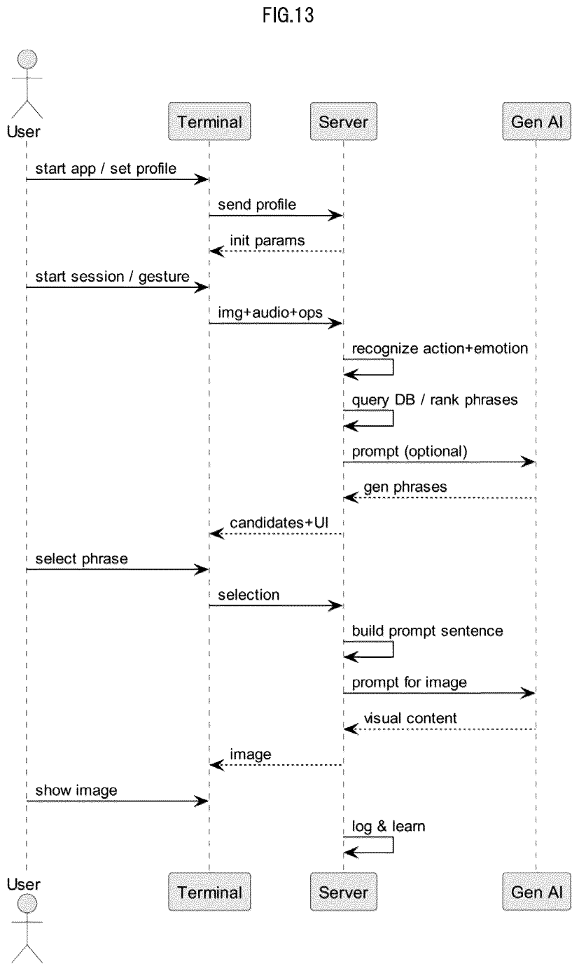

The following describes the processing flow using FIG. 13.

### Step 1:

User launches the dedicated application on the terminal and configures initial settings.

User provides input including preferred language, region, and visual style (for example, manga-style, bright colors) through on-screen controls.

Terminal receives, as input, the user's selections from UI components, performs data processing by validating each field and converting them into a structured configuration record, and outputs a user profile object.

Terminal stores the user profile object in local storage and sends it as a request payload to the server via a secure communication channel.

Server receives, as input, the user profile object, executes data operations including parsing, format checking, and assignment of a persistent user identifier, and outputs a stored profile record in a database and an initialization response containing the confirmed user identifier and default system parameters.

### Step 2:

User positions the terminal so that the user's face, gestures, and surrounding objects are visible to the camera and starts an interaction session from the application.

Terminal receives, as input, a session start command from the user, activates the camera and microphone through the operating system APIs, and begins acquiring image frames and audio samples.

Terminal performs data processing by downscaling each raw camera frame to a target resolution, encoding it into a compressed image format, and segmenting audio into time-stamped chunks.

Terminal also receives, as input, low-level touch and gesture events from the input subsystem, converts them into operation history entries containing timestamps, coordinates, and event types, and outputs a structured operation log.

Terminal aggregates a batch of image frames, an audio chunk, and a segment of the operation log into a multimodal packet and transmits this packet to the server as the current context input.

### Step 3:

Server receives, as input, the multimodal packet containing image data, audio data, and operation history data from the terminal.

Server performs data processing by decoding compressed images into pixel arrays, normalizing color channels, and resampling audio to a fixed sampling rate.

Server parses the operation history into an ordered list of events and aligns timestamps across modalities.

Server outputs pre-processed tensors for images, a normalized waveform or feature matrix for audio, and a cleaned event sequence for interaction, and delivers these outputs as inputs to recognition pipelines.

### Step 4:

Server executes the first recognition unit using the pre-processed image tensors as input.

Server applies data operations by feeding individual frames into an object detection neural network, computing bounding boxes, object class labels (for example, cup, bottle, plate), and confidence scores, and filtering out detections below a predefined threshold.

Server constructs a temporal stack of consecutive frames as input to an action recognition neural network and performs data computation to output probabilities for action labels such as lift, point, and drink.

Server combines, as input, the object labels and action probabilities and applies rule-based logic or a secondary classifier to merge sequences (for example, “lift cup to mouth”) into a higher-level action label (for example, drink).

Server outputs a first recognition result containing at least one identified action or activity and at least one identified object, each with confidence values, and passes this result to subsequent modules.

### Step 5:

Server executes the second recognition unit using, as input, the pre-processed image tensors, audio features, and operation history statistics.

Server performs data processing on images by detecting face regions, cropping them, resizing the crops, and feeding them into a facial emotion recognition neural network to compute category probabilities over emotions such as joy, sadness, anger, anxiety, and neutral.

Server processes the audio waveform to extract acoustic features and inputs these features into a speech emotion recognition model to obtain additional emotion probabilities over the same or similar categories.

Server summarizes operation history data by computing statistics such as tap frequency, average tap interval, and mis-tap ratio, and inputs these statistics into a classifier to compute scalar scores for tension level and confusion level.

Server then uses a multimodal fusion network, receiving as input the facial emotion probabilities, the speech emotion probabilities, and the interaction-based scores, and performs data computation using attention weights or other learned combination functions to output a fused emotional state.

Server outputs a second recognition result containing a dominant emotional category, continuous intensity values for one or more emotions, and numeric tension and confusion levels.

### Step 6:

Server executes the candidate generation unit using, as input, the first recognition result (action and object labels) and the second recognition result (emotional state).

Server formulates a database query using recognized action, object, emotion, language code, and region code and sends this query to the language database unit.

Server receives, as input from the database, a set of raw language expression candidate records, each including text and associated attributes.

Server performs data computation by calculating, for each candidate, a composite score derived from action-match, emotion-match, global usage frequency, and user-specific usage frequency, each multiplied by a scoring parameter.

Server normalizes candidate scores, sorts the candidates according to descending score, and outputs a ranked candidate list as structured data, which includes candidate identifiers, texts, and scores.

### Step 7:

Server optionally augments the ranked candidate list by interacting with a generative AI model for language.

Server constructs, as input to the generative AI model, a prompt sentence that encodes the recognized action, object, emotional state, target language, and desired tone and length.

Server, for example, generates the following prompt sentence:

The user is lifting a cup to drink and the detected emotion is “joy”. Assume a friendly conversation with friends. Generate 5 short Japanese phrases that express a fun, cheerful toast.

Return only the phrases, one per line, without additional explanation.

Server sends this prompt sentence to the generative AI model, receives a generated text output containing multiple lines, and splits this output into individual candidate phrases.

Server filters the generated phrases based on minimum length, duplication with existing candidates, and basic validity checks, and then merges the filtered set with the database-derived candidate list.

Server re-computes scores for the merged candidate set, treating generative candidates as new entries with initial frequency parameters, and outputs an updated ranked candidate list.

### Step 8:

Server executes the candidate presentation unit using, as input, the updated ranked candidate list and the second recognition result, including tension and confusion levels.

Server performs data computation by mapping tension and confusion levels to user interface control parameters, such as maximum display count, character size, spacing between candidate elements, and background style.

Server constructs a user interface configuration object that includes selected candidates, their display order, and the visual layout parameters, and outputs this configuration.

Server sends the configuration object to terminal as a response packet for user interface rendering.

### Step 9:

Terminal receives, as input, the user interface configuration object containing candidate data and layout parameters.

Terminal performs data processing by parsing the configuration object, instantiating local data structures for each language expression candidate, and configuring the graphical user interface framework according to the specified parameters (for example, setting font size, button spacing, and theme colors).

Terminal renders, as output, the candidate expressions as interactive elements on the display, ordered according to the ranking provided by the server.

User views the displayed options and provides input by tapping or otherwise selecting a candidate expression that best matches the user's intention.

Terminal receives, as input, the selection event, identifies the selected candidate identifier and associated text, and creates a selection record including a timestamp and session identifier.

Terminal outputs the selection record by transmitting it to the server for further processing.

### Step 10:

Server receives, as input, the selection record from terminal and retrieves the current emotional state and user profile from active session data or persistent storage.

Server executes the prompt generation unit by combining the selected language expression, the dominant emotional state and its intensity, recognized action and object, and user preferences such as desired illustration style.

Server performs data processing by constructing a natural language description that specifies visual elements of a scene, including characters' expressions and actions, objects present, background environment, color tone, and graphic style.

Server, for example, outputs a prompt sentence such as:

The user has selected the phrase “Let's toast together!” and the emotion is “joy”. Generate a bright, manga-style illustration where several smiling people are clinking their glasses in a toast. Use vivid colors and show a simple party venue in the background.

Server supplies this prompt sentence as input to a generative AI model for images and sets generation parameters such as resolution and guidance scale, and outputs a visual content request to the visual content generation unit.

### Step 11:

Server executes the visual content generation unit using, as input, the prompt sentence and generation parameters.

Server encodes the prompt sentence into a numerical embedding using a text encoder component of the generative AI model and performs data computation by iteratively updating a latent image representation through a diffusion or similar generative process.

Server outputs an image tensor representing generated visual content and performs post-processing by adjusting brightness, contrast, and size using an image processing library.

Server encodes the processed image into a compressed image format and outputs the encoded visual content as a binary payload, which is then transmitted to terminal.

### Step 12:

Terminal receives, as input, the encoded visual content from the server.

Terminal decodes the compressed image into a bitmap or equivalent structure, performs any final scaling needed to match the display resolution, and outputs the visual content on the display alongside, optionally, the selected text expression as a caption.

User presents the displayed image to another person by physically showing the terminal screen, thereby transmitting the user's intention and emotional nuance through the combination of text and visual content.

### Step 13:

Server executes the learning unit using, as input, logs collected over multiple sessions, including candidate presentation history, selection history, emotional state records, and visual content usage statistics, such as viewing duration and regeneration events.

Server performs data processing by aggregating these records per user and per context (for example, action, object, and emotion combination), and constructs training samples representing successful and unsuccessful communication outcomes.

Server applies a machine learning algorithm to these training samples to update scoring parameters for the candidate generation unit, mapping functions from emotional state to user interface control parameters for the candidate presentation unit, and rule parameters governing the inclusion and weighting of elements in prompt sentences for the prompt generation unit.

Server outputs updated parameter sets and persists them in configuration storage so that subsequent sessions use revised scoring, layout, and prompt construction behavior, thereby improving selection accuracy, reducing user interaction steps, and optimizing usage of the generative AI model over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional communication support systems for users with impaired speech or cognitive limitations typically rely on static phrase sets, simple button selection interfaces, or rule-based mappings from recognized gestures to fixed text. These systems generally perform isolated object or gesture recognition and then retrieve a predetermined phrase from a language database. As a result, such systems are limited in several respects.

First, traditional systems do not integrate multi-modal signals such as fine-grained body motion, facial expression dynamics, and acoustic features into a unified computational representation. In typical architectures, image recognition modules and audio analysis modules, if present, operate independently and do not produce a joint intent and emotion model. This separation prevents the system from accurately capturing subtle emotional nuances or urgency associated with a user's state, and leads to generic outputs that are poorly calibrated to the user's real needs.

Second, existing systems generally lack a robust mechanism for constructing context-dependent prompt sentences for generative AI models. In many cases, if generative models are used at all, they are invoked with manually crafted or static prompts that do not fully reflect the recognized motion, inferred intent, emotional state, and historical interaction context of a particular user. This results in inconsistent or low-relevance generated text and images, and does not effectively exploit the capabilities of modern generative AI models.

Third, conventional interfaces typically do not compute or present structured priority information and urgency information at the level of individual language expression candidates. Even when multiple candidate phrases are available, they are often shown as a flat list without machine-computed ranking based on estimated urgency, emotional intensity, or user-specific history. Consequently, a support user, such as a caregiver, must manually infer which candidate is most urgent or appropriate, which imposes cognitive load and increases the risk of delayed or inadequate responses in time-critical situations.

Fourth, known systems do not tightly couple visual communication image generation with the underlying intent and emotion recognition pipeline. Image suggestions, if provided, are usually pre-authored pictograms or icons that do not adapt to the current context, emotional state, or user preference. There is no systematic generation of image prompts based on recognized motion, estimated emotion, and selected or high-priority language expressions, and no automatic alignment between textual candidates and visual communication images.

Fifth, feedback from support users and from interaction outcomes is rarely used in a structured way to improve the underlying computational models. In typical systems, logs may be stored for auditing purposes, but there is no integrated feedback learning mechanism that uses selection information, evaluation information, and user-specific selection history as training data to update parameters of motion recognition models, emotion recognition models, and candidate generation and ranking logic. This absence of closed-loop learning prevents the system from improving over time, and from adapting to the individual patterns, preferences, and changing conditions of each user.

From a computer technology perspective, these limitations manifest as an architecture that (i) does not fully leverage multi-modal time-series inference to form a unified context representation, (ii) does not algorithmically construct high-fidelity prompt sentences to control generative AI models, (iii) does not implement machine-driven prioritization and urgency computation for candidate outputs, and (iv) does not incorporate structured user feedback into parameter updates for the recognition and generation pipeline. As a result, computing resources are not used optimally, inference accuracy and robustness are limited, and the interaction loop between recognition, generation, and user feedback remains largely manual and static.

Accordingly, there is a need for a computer-implemented system that integrates motion recognition, emotion recognition, and generative AI control in a unified architecture, that automatically generates prompt sentences conditioned on recognized intent and emotional state, that computes priority and urgency for each generated language expression candidate, that generates context-aligned visual communication images, and that uses explicit feedback from support users to continuously refine the underlying models. Such a system would improve the technical functioning of the communication support platform itself, by enabling more accurate, efficient, and adaptive processing of multi-modal input and generative output.

The specific processing by the specific processing unit 290 of the data processing device 12 in Application Example 2 is realized by the following means.

The present invention provides a server comprising a processor configured to acquire image data of a subject from an imaging unit and acoustic data from an acoustic acquisition unit, perform pose estimation and object detection on the image data to recognize a motion of the subject and estimate intent information of the subject, perform time-series analysis of expression features, posture features, and acoustic features to estimate an emotional state and an intensity of the emotional state of the subject, construct a unified context including the intent information, the emotional state, and user history information, generate a first prompt sentence for input to a first generative AI model based on the unified context, obtain from the first generative AI model a plurality of language expression candidates, calculate priority information and urgency information for the plurality of language expression candidates based on the unified context, present the plurality of language expression candidates together with the priority information and the urgency information via a display interface, generate a second prompt sentence for input to a second generative AI model based on at least one of the plurality of language expression candidates and the emotional state, obtain from the second generative AI model visual communication image data corresponding to a state or need of the subject, present at least one of the plurality of language expression candidates and the visual communication image data via the display interface to a support user, acquire selection information and evaluation information from the support user via an input interface, store the selection information and the evaluation information as feedback data, and update at least one parameter or weight coefficient of at least one model used for motion recognition, emotion recognition, or generation and ranking of the plurality of language expression candidates based on the feedback data. This enables a computer-implemented communication support system to more accurately infer user intent and emotional state from multi-modal input, to automatically construct context-adaptive prompt sentences that control generative AI models for text and image generation, to algorithmically prioritize and present candidate outputs according to urgency and relevance, and to continuously improve recognition and generation performance through integrated feedback learning, thereby improving the technical functioning and efficiency of the underlying computing system.

The term “processor” refers to a hardware computation unit or a combination of hardware computation units, including at least one central processing unit and optionally one or more accelerators, configured to execute instructions and perform the operations specified in the system.

The term “imaging unit” refers to an apparatus configured to capture image data of a subject and surrounding objects, including at least one of a fixed imaging apparatus and a portable imaging apparatus.

The term “acoustic acquisition unit” refers to an apparatus configured to capture acoustic data in a monitored environment, including at least one of a microphone, an array microphone, and an audio input interface.

The term “image data” refers to digital data representing at least one still image or a series of images obtained from the imaging unit, in which a subject and surrounding objects are captured.

The term “acoustic data” refers to digital data representing sound captured by the acoustic acquisition unit, including speech, non-speech vocalizations, and environmental sounds.

The term “pose estimation” refers to processing for estimating positions of anatomical keypoints of a subject, such as head, shoulders, elbows, wrists, hips, knees, and ankles, from image data.

The term “object detection” refers to processing for locating and classifying objects within image data by determining bounding regions and associated category labels.

The term “motion” refers to a temporal pattern of changes in the position or orientation of at least part of the subject's body, identified from image data by pose estimation, object detection, or both.

The term “intent information” refers to information representing an inferred purpose, request, or state of the subject, derived from recognized motion and associated context.

The term “expression features” refers to numerical representations of facial attributes, including at least positions and shapes of facial components such as eyes, eyebrows, nose, and mouth, extracted from image data.

The term “posture features” refers to numerical representations of global or local body configuration, including at least torso orientation, degree of forward or backward lean, limb angles, and body symmetry, extracted from pose estimation results.

The term “acoustic features” refers to numerical representations of characteristics of acoustic data, including at least spectral coefficients, pitch, energy, and temporal patterns, computed from signals captured by the acoustic acquisition unit.

The term “time-series analysis” refers to processing for analyzing sequences of features ordered in time to model temporal dependencies, including at least recurrent neural network processing, temporal convolution, or sequence modeling.

The term “emotional state” refers to information representing an inferred psychological or affective condition of the subject, including at least one categorical label, such as anxiety, pain, discomfort, calm, or relief, and an associated intensity value.

The term “unified context” refers to structured data combining at least intent information, emotional state information, and user history information, together with meta-information including user identifier and timestamp.

The term “user history information” refers to stored data representing past interactions of a subject or support user with the system, including at least past selections of language expression candidates, evaluation information, and previously estimated states.

The term “prompt sentence” refers to a natural language instruction or description constructed as input to a generative AI model, specifying at least contextual information, desired output characteristics, and constraints.

The term “first generative AI model” refers to a generative artificial intelligence model trained to generate text data in response to a prompt sentence, including at least a large language model.

The term “second generative AI model” refers to a generative artificial intelligence model trained to generate image data in response to a prompt sentence, including at least a model based on a generative neural network or a diffusion process.

The term “language expression candidate” refers to a candidate natural language text segment generated by the first generative AI model, representing a possible expression of the subject's state, need, or request.

The term “priority information” refers to information indicating a relative order or importance of individual language expression candidates, computed based on at least intent information, emotional state, and user history information.

The term “urgency information” refers to information indicating a degree of urgency or required response speed associated with at least one language expression candidate or unified context, represented by a label or a numerical score.

The term “visual communication image data” refers to image data generated by the second generative AI model that visually represents a state, need, or request of the subject, including at least one of an illustration image and a comic-style image.

The term “display interface” refers to a hardware and software component configured to present information to a support user, including at least one display device and a graphical user interface.

The term “input interface” refers to a hardware and software component configured to receive input from a support user, including at least one of a touch panel, a pointing device, a keyboard, a voice input interface, and an input form.

The term “support user” refers to a person who assists the subject, including at least a caregiver, an operator, or an attendant who views and selects language expression candidates and provides feedback to the system.

The term “selection information” refers to data indicating which language expression candidate or candidates have been selected by a support user among the plurality of language expression candidates presented.

The term “evaluation information” refers to data indicating an assessment by the support user of at least one language expression candidate, recognition result, or generated output, including at least an appropriateness label or a comment.

The term “feedback data” refers to data comprising at least selection information, evaluation information, and user history information, stored for use in updating parameters of models used by the system.

The term “model parameter” refers to a numerical value used in a computational model, including at least a weight, a bias, a threshold, or a coefficient, which determines behavior of a motion recognition model, an emotion recognition model, or a generation and ranking model.

The term “weight coefficient” refers to a parameter that scales or weights a feature, score, or intermediate output within at least one model used in the system, and that can be updated based on feedback data.

In one embodiment, a server, a terminal, and a user cooperate to implement the claimed system. The server includes at least one processor, main memory, non-volatile storage, and a network interface. The server is connected via a communication network to one or more imaging units and acoustic acquisition units disposed in a care facility. The terminal includes a display interface, an input interface such as a touch panel, and a wireless communication module, and is operated by a support user. The user includes a subject whose state is to be recognized and a support user who interprets and acts on outputs of the system. The server operates under a general-purpose operating system, and executes application software implemented in an application framework. The server uses a numerical computation library and a deep learning framework to perform pose estimation, object detection, emotion estimation, and generative AI inference. The server also uses an image processing library to process image data and a database management system to store context data, model parameters, and feedback data. The specific names of these components can include, for example, a server-class operating system, a web application framework, a relational database, an image processing library, and a deep learning framework, but the invention is not limited to particular products.

The server receives image data from the imaging unit via a video streaming protocol. The server uses the image processing library to decode the image stream into individual frames, adjust resolution, and normalize colors. The server manages image frames and related meta-information in a structured data format, for example, a record containing a frame identifier, timestamp, user identifier, and camera identifier. The server stores or buffers these records in memory or in a database for further processing.

The server applies a pose estimation model implemented in the deep learning framework to the image frames. In one embodiment, the pose estimation model is a multi-layer convolutional neural network that outputs heatmaps and offset maps for multiple body keypoints. The server post-processes the network outputs to obtain coordinates of anatomical keypoints such as head, shoulders, elbows, wrists, hips, knees, and ankles. The server computes feature vectors from these keypoints, including joint angles, relative positions between keypoints and detected objects, and measures of body orientation. The server normalizes these feature vectors, for example, by scaling coordinates relative to body size and camera resolution, and stores them as numerical arrays.

The server also applies an object detection model implemented in the deep learning framework to each frame. The object detection model can include a backbone network and detection heads that output bounding boxes, class scores, and confidence values. The server associates detected objects, such as cups, beds, or furniture, with the subject by checking spatial relations between subject keypoints and bounding boxes. For example, the server determines that the subject is pointing at a cup when the fingertip keypoint lies within or near a bounding box labeled as a container. This association is recorded in a motion recognition record.

The server implements a motion classification model that takes the feature vectors as input. In one embodiment, the motion classification model is a fully connected neural network with an input layer, one or more hidden layers, and an output layer that encodes motion categories such as “raising hand,” “pointing to object,” “holding abdomen,” or “grabbing bed rail.” The server computes the output probabilities by applying activation functions and a softmax layer over the motion categories. The server selects the motion label with the highest probability as the recognized motion. The server logs both the selected label and the probability distribution to allow later analysis and learning.

The server maps the motion label to intent information by referring to an intent mapping table stored in the database. This table associates motion labels with intent types, such as “wants a drink,” “wants to go to the toilet,” “feels pain,” or “is calling for help,” and may include additional fields describing typical urgency or associated body regions. The server retrieves the corresponding intent type and forms an intent information object containing the intent type, a confidence score, and references to the motion recognition record.

The server applies a facial expression recognition model to face images cropped from the frames. In one embodiment, the facial expression recognition model is a convolutional neural network trained on annotated facial expression data. The server feeds normalized face images into the model, which outputs class probabilities for basic expressions such as happiness, sadness, fear, anger, disgust, and neutral. The server selects the expression with the highest probability and converts the probability distribution into a set of expression features.

The server extracts posture features based on the output of the pose estimation model. These posture features can include, for example, torso lean angle, distance between shoulders and head, degree of contraction or expansion of the body, and measures of tremor or instability inferred from frame-to-frame displacement of keypoints. The server computes time-series of these features over a sliding temporal window.

When acoustic data is available, the server uses an audio analysis library to compute acoustic features such as spectral coefficients, pitch contours, energy envelopes, and speaking rate.

The server aligns these acoustic features with corresponding time intervals of the image frames, and stores them in synchronized feature sequences.

The server implements an emotion estimation model for time-series analysis, in one embodiment using a recurrent neural network such as a long short-term memory (LSTM) network or gated recurrent unit (GRU). The server constructs input sequences combining expression features, posture features, and, when available, acoustic features over a predefined temporal window. The server feeds these sequences into the recurrent network, which processes the sequences through time, maintaining hidden states that encode temporal dependencies and patterns. The network outputs continuous scores for emotion dimensions such as anxiety level and pain level, and may also output categorical labels such as “anxiety,” “strong pain,” “mild discomfort,” “calm,” or “relief” The server forms an emotion state object containing these labels and scores.

The server constructs a unified context object by combining the intent information, the emotion state, and user history information. The user history information can include prior context objects, past selections of language expression candidates by the support user, and previous emotional states associated with specific intents. The unified context object includes fields such as motion label, intent type, emotion label, numerical intensity values, user identifier, timestamp, camera identifier, and references to relevant historical events. The server stores the unified context object in the database as a structured record. This unified context data structure allows the server to perform subsequent processing in a way that jointly optimizes text and image generation based on multiple modalities.

The server generates a first prompt sentence for a text generative AI model. The server uses a prompt construction module implemented in the application layer to convert the unified context into natural language. The server applies template logic that inserts the motion description, the inferred intent, the emotional state, and constraint conditions such as output language, politeness level, and maximum character count. The server also incorporates user-specific preferences, for example, whether the support user prefers concise explanations or more detailed statements.

In one example, the server generates the following first prompt sentence in text format:

“You are an assistant that generates messages for caregiving staff.

### The Situation is as Follows:

User's motion: pointing at a cup on the table.
Estimated user intent: wants a drink.
User's emotion: mild anxiety (anxiety level 0.6), almost no pain.
The user has difficulty speaking.

Generate three short Japanese sentences that convey the user's need to the caregiving staff.

### Conditions:

Use polite style.
Each sentence must be no longer than 30 Japanese characters.
Each sentence must clearly express that the user wants a drink and feels a little anxious.”

The server sends the first prompt sentence to the text generative AI model, which may be hosted on the same server or on a separate computing platform. The server communicates with the generative AI model through a program interface, transmitting the prompt sentence and receiving text output. The generative AI model is a trained large-scale neural network that generates text tokens based on the input prompt and its internal parameters. The server receives the generated text, which typically contains multiple candidate sentences, and parses the text into individual language expression candidates.

The server applies a filtering and ranking pipeline to the language expression candidates. The server uses a natural language processing component to check for length, style, and presence of prohibited or undesirable words, and discards candidates that do not satisfy basic constraints. The server constructs feature vectors for each remaining candidate, including, for example, candidate length, presence of specific keywords, similarity to past selected candidates, and alignment with the inferred intent and emotional state. The server computes priority information and urgency information for each candidate by applying a scoring function that may include learned weights. These weights can be stored as parameters in a model that incorporates factors such as emotion intensity, typical urgency associated with the intent type, and support user's historical preferences. The server then sorts the candidates according to priority and attaches urgency labels such as “high,” “medium,” or “low.”

The server generates a second prompt sentence for an image generative AI model. The server selects either the highest-priority language expression candidate or a candidate explicitly selected by the support user in previous interactions, and combines it with the unified context and user or subject preferences about visual style. The server constructs a textual scene description that specifies characters, their positions and actions, their facial expressions, the environment, color tone, and illustration style. The server can optionally ask the text generative AI model to transform this description into a highly detailed prompt optimized for an image model. In one example, the server constructs the following prompt request:

“Create an English prompt for Stable Diffusion.

### Situation:

User's need: wants to drink water.
User's emotion: mild anxiety.
Content to depict:

The user is pointing to a cup on the table, and a caregiver with a gentle expression is approaching while holding a cup filled with water.
Mood: bright, warm colors that convey safety and reassurance.
Style: soft-touch illustration, anime-like but not too realistic.

### Output Format:

A single English sentence that can be used directly as a Stable Diffusion prompt.
About 50-80 words.”

The server sends this prompt request to the text generative AI model, receives a resulting English prompt sentence, and passes the English prompt sentence as input text to the image generative AI model. The image generative AI model can be, for example, a diffusion-based neural network that iteratively refines a random or noisy image towards a final image that matches the textual prompt. The server configures the image generation process through parameters such as number of sampling steps, guidance scale, and output resolution. The server receives the generated image as a numerical tensor, converts it to a standard image format, stores it in a file system or object storage, and records its location in the database as visual communication image data associated with the unified context.

The terminal periodically or on demand queries the server for new unified contexts and associated language expression candidates and images. The terminal receives structured response data from the server, including the plurality of candidates, their priority information and urgency information, the emotional state summary, and references to visual communication image data. The terminal renders this information in a graphical user interface, for example by listing the candidate sentences in descending order of priority and highlighting high-urgency candidates using color or icons. The terminal displays the corresponding visual communication image next to the text, allowing the support user to quickly understand the subject's inferred need and emotional state.

The user, acting as a support user, interacts with the terminal via the input interface. The user selects the most appropriate language expression candidate by tapping or clicking on it, and may also enter evaluation information indicating whether the candidate accurately represents the subject's state, or if the recognition appears to be incorrect. The user can also provide short comments. The terminal records this selection information, evaluation information, and contextual meta-information such as time and user identifier, and sends it to the server.

The server stores the received feedback data in the database. The feedback data includes, for example, identifiers of the unified context, the selected candidate, the priority and urgency at the time of selection, and the evaluation label. At scheduled times or when sufficient feedback has accumulated, the server executes a learning process. The server loads motion recognition training data consisting of pairs of input feature sequences and corrected motion labels or intent labels derived from feedback. The server applies a supervised learning algorithm to update parameters of the motion classification model, for example using a gradient-based optimization method and a loss function such as cross-entropy between predicted labels and corrected labels.

Similarly, the server refines the emotion estimation model by comparing model output with support user feedback on emotional states, and adjusts recurrent network weights to minimize discrepancies. For the candidate ranking model, the server treats support user selections as implicit relevance labels, and uses a ranking loss or pairwise loss to adjust weights in the scoring function that determines priority and urgency. The server can also perform data augmentation, for example by perturbing feature vectors within plausible ranges or by sampling additional negative examples from unselected candidates. By updating model parameters in this manner, the server improves the accuracy of motion and emotion recognition, as well as the quality of candidate ranking, over time.

The described configuration provides technical effects beyond mere automation of human decisions. The server uses multi-modal signal processing and time-series modeling to form a unified context that is difficult for a human operator to compute reliably at scale. The server automatically generates prompt sentences that encode complex contextual constraints for generative AI models, thereby controlling generative outputs in a way that is dynamically adapted to the subject's recognized state. The server's feedback learning mechanism directly links real-world outcomes to internal model parameters, enabling continuous calibration and reduction of systematic errors. As a result, the system increases recognition accuracy, reduces response time, and optimizes communication bandwidth between server and terminal by transmitting compact structured representations rather than raw data streams.

In another embodiment, the server can adjust communication frequency or compression method based on urgency information, thereby reducing network load when no urgent events are detected, while still ensuring rapid updates in high-urgency situations. In some embodiments, the server can run lightweight models on the terminal for preliminary filtering and use the full models on the server only when more detailed analysis is required, further improving computational efficiency.

Various modifications and alternatives can be implemented. The pose estimation model may be replaced by different architectures, for example, a transformer-based vision model. The emotion estimation model may incorporate attention mechanisms over time to emphasize salient frames. The generative AI models may be hosted locally or accessed via different communication protocols. The ranking logic may use decision trees, gradient boosting, or linear models instead of neural networks, depending on system constraints. Regardless of such variations, the server, the terminal, and the user cooperate in a pipeline that uses generative AI models and carefully constructed prompt sentences, multi-modal recognition, and feedback-driven learning to improve the technical performance of a computer-implemented communication support system.

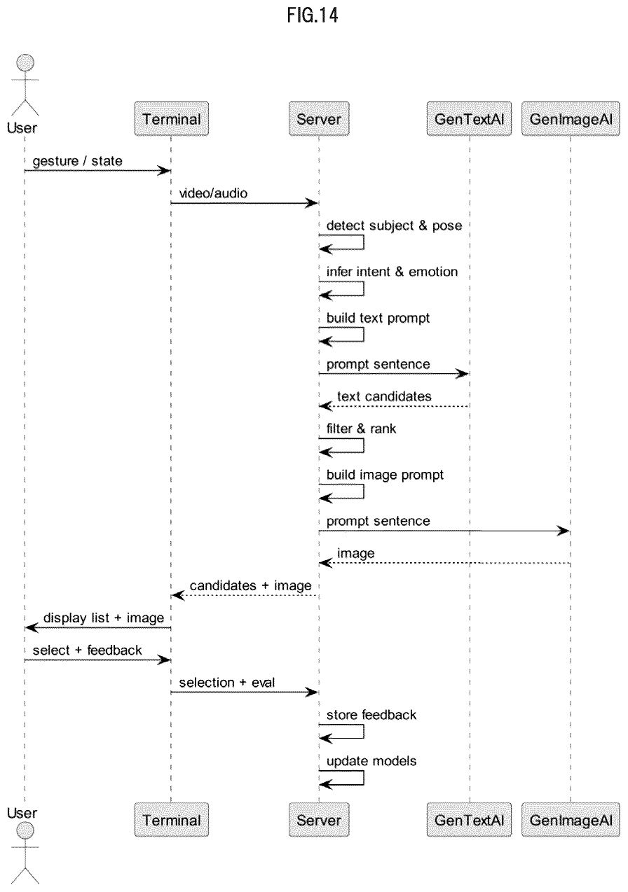

The following describes the processing flow using FIG. 14.

### Step 1:

Server acquires raw sensor data.

Server receives as input a video stream from an imaging unit and, when available, an audio stream from an acoustic acquisition unit. Server uses an image processing library to decode the video stream into individual frame images and to convert the audio stream into a sequence of audio buffers. Server performs data processing on the video by resizing frames, normalizing color channels, and optionally applying noise reduction, thereby generating as output a sequence of preprocessed frame images with associated timestamps. Server performs data processing on the audio by resampling, normalizing amplitude, and segmenting into time windows aligned with the frame timestamps, thereby generating as output preprocessed audio segments.

### Step 2:

Server detects subjects and faces in each frame.

Server receives as input the sequence of preprocessed frame images from Step 1. Server applies an object detection algorithm implemented in a deep learning framework to each frame in order to detect person regions and relevant objects such as containers, furniture, and medical equipment. Server further applies a face detection algorithm to locate facial regions within the person regions. Server performs data processing by computing bounding boxes and classification scores, assigning a unique subject identifier to each tracked person over consecutive frames. Server outputs, for each frame, a structured record including a subject identifier, a cropped body image, a cropped face image, detected object bounding boxes, and the frame timestamp.

### Step 3:

Server estimates body pose and extracts motion features.

Server receives as input the cropped body images and associated metadata from Step 2. Server applies a pose estimation model to each body image to compute 2-dimensional coordinates of anatomical key points such as head, shoulders, elbows, wrists, hips, knees, and ankles. Server performs data processing by normalizing the key point coordinates relative to body size and image resolution, and then calculating derived features, including joint angles, distances between key points, and relative positions of hands and fingertips to detected objects. Server aggregates these numerical values into a motion feature vector for each frame and outputs a time-ordered sequence of motion feature vectors associated with each subject identifier.

### Step 4:

Server recognizes motion and infers intent information.

Server receives as input the time-ordered sequence of motion feature vectors and detected object information from Step 3. Server applies a motion classification model to each feature vector or to short sequences of feature vectors, performing numerical computation to obtain class probabilities over predefined motion categories such as “raising hand,” “pointing to object on table,” “holding abdomen,” or “grabbing bed rail.” Server selects the motion label with the highest probability for each time point and smooths the sequence over time to reduce noise. Server then refers to an intent mapping table stored in a database and performs data lookup to convert motion labels into intent types such as “wants a drink” or “feels pain.” Server outputs an intent object containing the inferred intent type, confidence scores, and references to the subject identifier and timestamps.

### Step 5:

Server extracts facial expression and posture features.

Server receives as input the cropped face images and pose estimation results from Steps 2 and 3. Server applies a facial expression recognition model to each face image, performing convolutional operations to compute probabilities for expression classes such as “happiness,” “sadness,” “fear,” “anger,” “disgust,” and “neutral.” Server selects the dominant expression class and encodes the probability distribution as an expression feature vector. Server also derives posture features from the pose estimation results by computing, for example, torso lean angle, head tilt, and relative distances between shoulders and hips. Server outputs, for each frame and subject identifier, a combined feature record that includes expression features and posture features.

### Step 6:

Server extracts acoustic features (when audio is available).

Server receives as input preprocessed audio segments from Step 1 that are time-aligned with frame timestamps. Server applies an audio analysis routine to each segment, performing spectral analysis to compute features such as Mel-frequency cepstral coefficients, pitch contours, energy measures, and temporal modulation indices. Server normalizes these features and aggregates them into acoustic feature vectors. Server then aligns these acoustic feature vectors with the corresponding subject identifier and time intervals based on the timestamps. Server outputs a sequence of acoustic feature vectors linked to the same temporal indices as the visual features.

### Step 7:

Server estimates emotional state using time-series analysis.

Server receives as input the time-ordered expression features, posture features, and, when present, acoustic feature vectors from Steps 5 and 6. Server concatenates these features into multi-modal feature sequences over a defined temporal window for each subject identifier. Server inputs these sequences into a time-series emotion estimation model, for example an LSTM network, and performs recurrent computations to propagate hidden states through time. Server calculates as output continuous emotion scores (e.g., anxiety level, pain level, discomfort level) and categorical emotional labels such as “anxiety,” “strong pain,” “mild discomfort,” “calm,” or “relief” for each subject and time interval. Server stores these emotion objects together with timestamps and subject identifiers.

### Step 8:

Server constructs unified context objects.

Server receives as input the intent objects from Step 4 and the emotion objects from Step 7, along with user history records stored in the database. Server performs data processing by merging fields from intent, emotion, and history, including recent events, past selections of text candidates, and previously estimated emotional states. Server constructs for each subject and time interval a unified context object that includes motion label, intent type, emotion label, numerical intensity values, subject identifier, timestamp, camera identifier, and references to user history entries. Server outputs these unified context objects and stores them in structured form in the database.

### Step 9:

Server generates a first prompt sentence for a text generative AI model.

Server receives as input a unified context object from Step 8. Server uses template logic in the application layer to convert individual fields of the unified context into natural language fragments. Server concatenates these fragments and explicit instructions into a complete prompt sentence, describing the subject's motion, inferred intent, emotional state, and constraints on the desired output text, such as language, style, and length. Server performs string formatting operations to incorporate context values (e.g., numerical emotion scores) into the text. Server outputs a first prompt sentence, for example:

“You are an assistant that generates messages for caregiving staff.

### The Situation is as Follows:

User's motion: pointing at a cup on the table.
Estimated user intent: wants a drink.
User's emotion: mild anxiety (anxiety level 0.6), almost no pain.
The user has difficulty speaking.

Generate three short Japanese sentences that convey the user's need to the caregiving staff.

### Conditions:

Use polite style ( [symbol] ).
Each sentence must be no longer than 30 Japanese characters.
Each sentence must clearly express that the user wants a drink and feels a little anxious.”

### Step 10:

Server obtains language expression candidates from the text generative AI model.

Server receives as input the first prompt sentence from Step 9. Server sends this prompt sentence to a text generative AI model via a programmatic interface, performing a network call or local function invocation. Server receives as raw output a text response that may contain several suggested sentences separated by line breaks or special markers. Server parses the response, splits it into individual sentences, and trims whitespace and control characters. Server outputs a preliminary list of language expression candidates derived from the generative AI model.

### Step 11:

Server filters and ranks language expression candidates.

Server receives as input the preliminary list of language expression candidates from Step 10 and the corresponding unified context object from Step 8. Server applies a text processing routine to each candidate, computing properties such as character count, presence of prohibited terms, and semantic similarity to the intended meaning. Server removes candidates that exceed specified length limits or contain undesired expressions. Server then constructs candidate feature vectors that include content features, length, similarity to intent description, emotion alignment, and historical selection statistics. Server applies a scoring function or ranking model to these feature vectors, computing priority information and urgency information for each candidate. Server outputs a refined list of language expression candidates, each annotated with a priority score and an urgency label such as “high,” “medium,” or “low.”

### Step 12:

Server generates a second prompt sentence for an image generative AI model.

Server receives as input at least one language expression candidate and the corresponding unified context object from Steps 11 and 8. Server selects either the highest-priority candidate or a candidate indicated by configuration rules, and combines it with the intent type, emotional state, and visual preference data stored for the subject. Server constructs a textual description of a scene that visually represents the subject's need and emotional state, including details about characters, actions, environment, color tone, and style. Server may generate a meta-prompt directed to a text generative AI model to obtain a well-structured English prompt for an image model. Server outputs a second prompt sentence, for example:

“Create an English prompt for Stable Diffusion.

### Situation:

User's need: wants to drink water.
User's emotion: mild anxiety.
Content to depict:

The user is pointing to a cup on the table, and a caregiver with a gentle expression is approaching while holding a cup filled with water.
Mood: bright, warm colors that convey safety and reassurance.
Style: soft-touch illustration, anime-like but not too realistic.

### Output Format:

A single English sentence that can be used directly as a Stable Diffusion prompt.
About 50-80 words.”

### Step 13:

Server obtains visual communication image data from the image generative AI model.

Server receives as input the second prompt sentence from Step 12. Server sends this prompt sentence to an image generative AI model configured to create images based on textual descriptions. Server specifies parameters such as output resolution and guidance strength. Server receives as output a generated image in the form of numerical pixel data. Server converts this data into a standard image file format, stores the file at a designated storage location, and records its file path or identifier in the database linked to the unified context. Server outputs a reference to this visual communication image data.

### Step 14:

Server transmits candidates and images to the terminal.

Server receives as input a request from the terminal for current communication support information for a particular subject. Server retrieves from the database the refined list of language expression candidates from Step 11, the associated priority and urgency information, the emotion summary from Step 7, and the reference to the visual communication image data from Step 13. Server packs this information into a structured response message that includes text fields and image references. Server sends this response message via a network interface to the terminal. Server outputs the transmitted data as a response to the terminal's request.

### Step 15:

Terminal displays information and collects user input.

Terminal receives as input the structured response message from Step 14. Terminal parses the message and extracts the language expression candidates, priority and urgency labels, emotion summary, and image reference. Terminal requests the corresponding image file from the server using the provided reference and receives the image data. Terminal performs data processing by arranging the candidates in order of priority and applying visual emphasis to high-urgency items. Terminal displays the candidate list and the image on the display interface. User, acting as a support user, views the display, selects the most appropriate candidate by touch or click, and optionally inputs evaluation information or comments. Terminal records the selected candidate identifier, the evaluation label, and any text comment, and outputs this selection information as a feedback message addressed to the server.

### Step 16:

Server stores feedback data and updates models.

Server receives as input the feedback message from Step 15, including selected candidate identifiers, evaluation information, and associated context identifiers. Server stores this information in the database as feedback data linked to the corresponding unified context, motion recognition results, emotion estimation results, and candidate ranking. At configured intervals or upon accumulation of sufficient feedback, Server retrieves batches of feedback data and associated input features, and uses them to construct training datasets. Server performs numerical optimization by computing loss functions, such as classification loss for motion and emotion models and ranking loss for candidate scoring models, and updates model parameters using gradient-based methods. Server outputs updated model parameters and deploys them into the inference pipeline, thereby improving recognition accuracy, candidate relevance, and responsiveness of subsequent processing cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

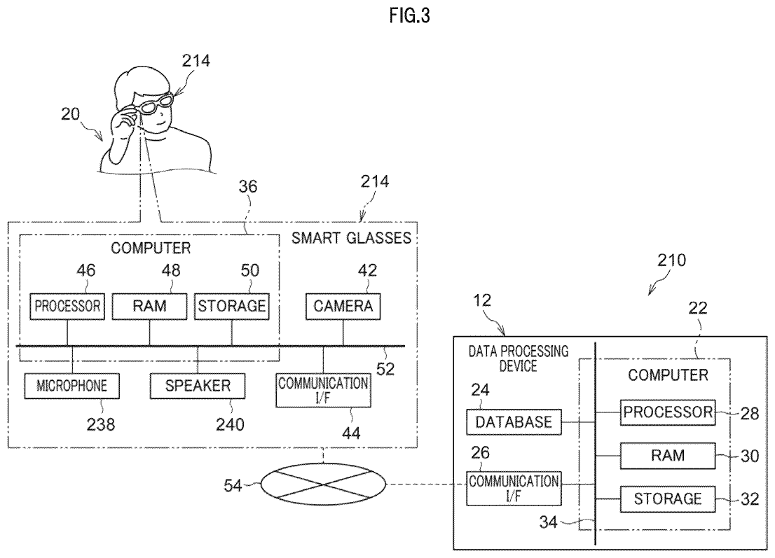

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

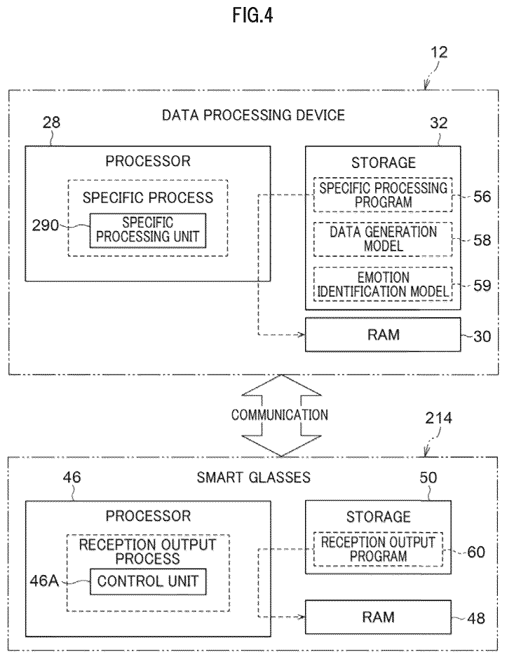

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

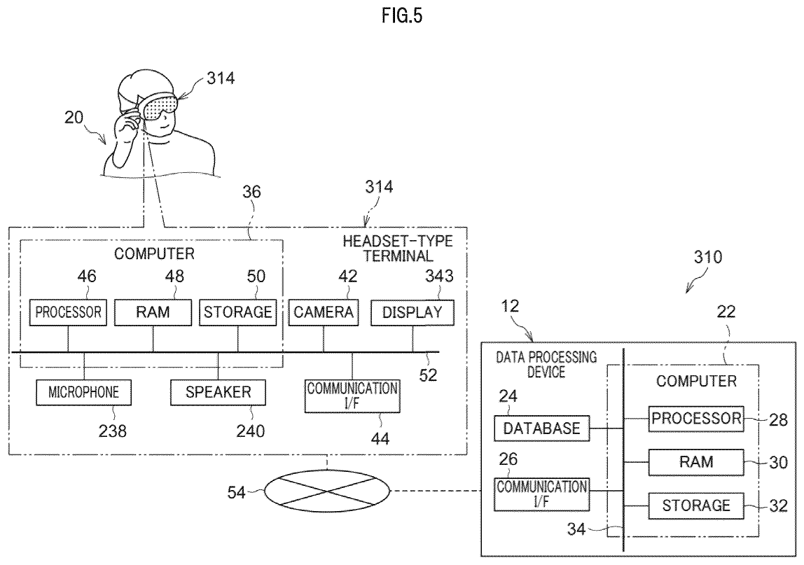

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

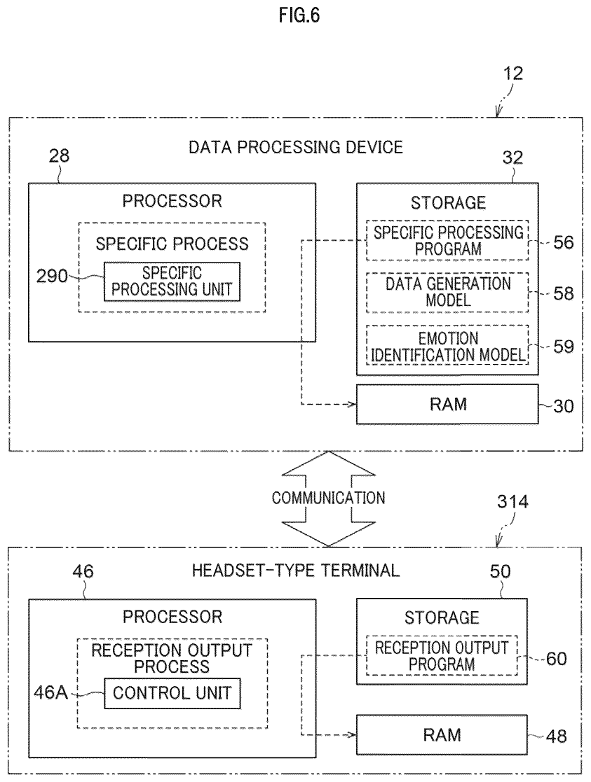

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

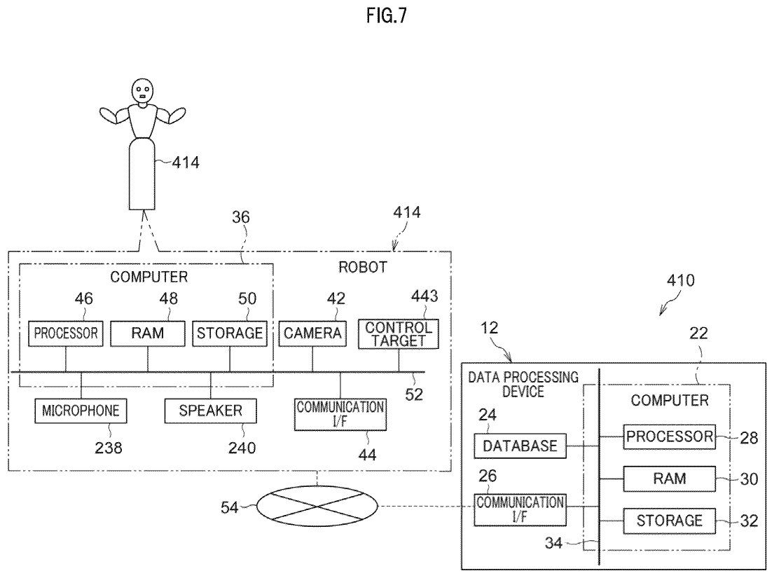

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

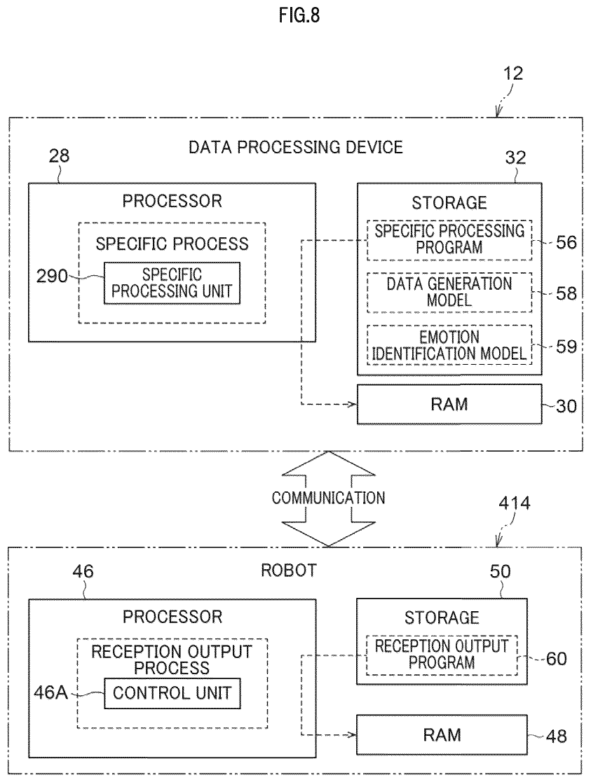

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

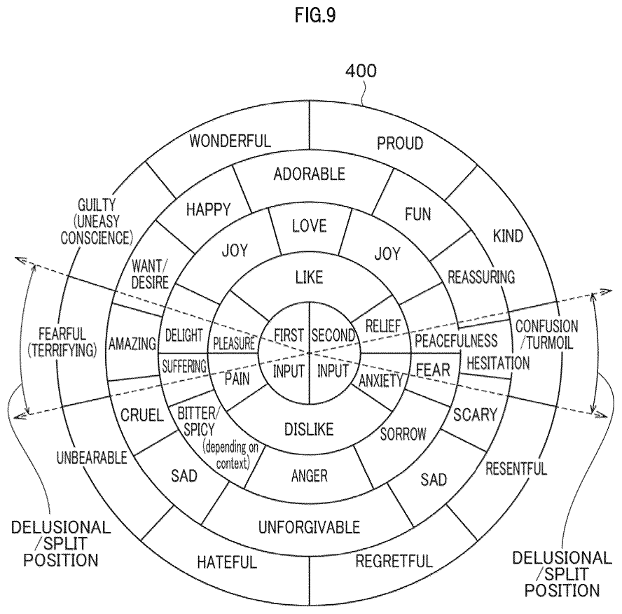

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

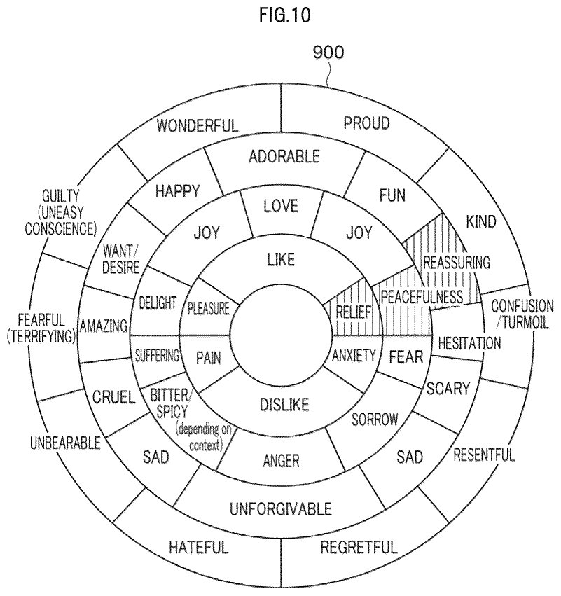

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire imaging information that captures gestures, facial expressions, and surrounding targets of a user,
extract targets and motions in a time series from the imaging information and recognize an action based on continuous posture changes,
store, in an information storage unit, a plurality of expression information items corresponding to the recognized action in association with language types and cultural conditions,
search, based on the action, a use history of the user, and environment information, the expression information and determine candidate expressions with assigned priorities,
present the candidate expressions to the user as text information and visual information and receive a selection operation from the user,
generate a prompt sentence to be input to a generative AI model, the prompt sentence being
generated based on the selected candidate expression, the action, and the environment information as input conditions,
cause the generative AI model to operate based on the prompt sentence and generate visual information including image information or story-form visual information that visually represents contents of the candidate expression,
present the generated visual information to the user and enable interpersonal communication using the visual information,
acquire a selection result of the candidate expression by the user, evaluation information for the visual information, and communication success information and accumulate the acquired information as learning data, and
update at least one parameter of a process of searching and prioritizing the candidate expressions and a process of generating the prompt sentence, based on the learning data.

### (Supplementary 2)

The system according to supplementary 1,
wherein the processor is configured to
acquire the imaging information from a portable information processing apparatus or a fixed installation-type imaging apparatus via a communication line, distribute functions between a processing apparatus that performs extraction of the targets and motions and a display input/output apparatus that performs presentation of the candidate expressions and acquisition of the selection operation from the user, and execute, in a centralized manner on the processing apparatus side, generation of the candidate expressions based on the recognized action, generation of the prompt sentence, and generation of the visual information by the generative AI model.

### (Supplementary 3)

The system according to supplementary 1,
wherein the processor is configured to
include, in generation of the candidate expressions, additional expression information obtained from a text generative AI model by inputting to the text generative AI model a prompt sentence including the recognized action and the environment information in addition to search results of the expression information stored in the information storage unit, and, in generation of the visual information, adjust style specification and content specification in the prompt sentence based on the evaluation information of the user.

### Application Example 1

### (Supplementary 1)

A system comprising a processor,
wherein the processor is configured to
acquire image information including gestures, postures, and facial expressions of a user from an imaging device, and perform preprocessing on time-series image data to generate preprocessed image data, and analyze the preprocessed image data by machine learning-based image analysis to identify the gestures, postures, and facial expressions of the user and estimate intent information representing an intention of the user based on identification results, and generate intent information including an identifier of the intent information and a confidence value,
store language information in which a plurality of language expressions corresponding to the intent information are stored in association with language types and cultural attributes in a hierarchical manner, and, based on the intent information and attribute information of the user, extract a plurality of candidate language expressions corresponding to the intent information from the language information,
generate, based on the intent information, the attribute information of the user, and usage history information, a first prompt sentence that uses the candidate language expressions as input to a generative artificial intelligence model, and input the first prompt sentence to the generative artificial intelligence model disposed externally or internally to obtain, from the generative artificial intelligence model, a result for addition or modification of the candidate language expressions, and update contents and priorities of the candidate language expressions based on the result,
cause a display unit of an information processing apparatus to present the updated candidate language expressions as selectable items arranged on a display screen according to the priorities, and acquire a selected language expression based on an operation input applied to at least one of the selectable items,
generate, based on the selected language expression and preference information of the user, a second prompt sentence for image generation to be input to a generative artificial intelligence model, input the second prompt sentence to the generative artificial intelligence model to obtain image information or visual information including a combination of a plurality of pieces of image information in a story format, and output the visual information as a visual communication means understandable to the user, and
accumulate selection results obtained by presenting the candidate language expressions, evaluation information indicating success or failure of communication based on presentation results of the visual information, and feedback information from the user and a communication partner, and update at least one of contents of the language information, the priorities of the candidate language expressions, and parameters of an intent estimation process in the machine learning-based image analysis based on the accumulated information.

### (Supplementary 2)

The system according to supplementary 1,
wherein the processor is configured to
batch a plurality of frames of image information acquired from the imaging device in time series, convert the batched image information into feature information, identify a plurality of gestures and facial expressions of the user simultaneously by using a deep learning model including at least a posture estimation model and a facial expression estimation model, and calculate one or more pieces of intent information and corresponding confidence values based on a combination of the gestures and facial expressions and at least one of position information and time information relating to the user.

### (Supplementary 3)

The system according to supplementary 1,
wherein the processor is configured to
calculate statistical information from selection results and evaluation information accumulated over a predetermined period, generate a third prompt sentence that uses dialog history data including the statistical information as input to a generative artificial intelligence model, input the third prompt sentence to the generative artificial intelligence model to obtain an update policy regarding recommended language expressions and display orders for each piece of intent information, and change, automatically or semi-automatically, at least one of the language information and processing conditions for generation of the candidate language expressions based on the update policy.

### Example 2

### (Supplementary 1)

A system comprising a processor,
wherein the processor is configured to
acquire image information including a user's gesture, facial expression, and surrounding object by using an imaging unit,
identify a user action or activity and an object on the basis of the image information acquired by the imaging unit by using a first recognition unit,
estimate an emotional state of the user on the basis of at least a part of the image information, acoustic information, and operation history information by using a second recognition unit, store, in a language database unit, language expression candidates in a plurality of languages in association with the action or activity identified by the first recognition unit, the object identified by the first recognition unit, and the emotional state estimated by the second recognition unit, and further store attribute information including an action attribute, an object attribute, an emotional attribute, and a usage frequency attribute for each of the language expression candidates,
generate, by using a candidate generation unit, a plurality of the language expression candidates by issuing a query to the language database unit on the basis of outputs of the first recognition unit and the second recognition unit, and by scoring and prioritizing the language expression candidates according to a degree of match with the action, a degree of match with the emotional state, a general usage frequency, and a user-specific usage frequency,
generate user interface control information including at least a display count, a character size, a spacing between display elements, and a background style on the basis of the language expression candidates generated by the candidate generation unit and the emotional state estimated by the second recognition unit,
present, by using a candidate presentation unit, the language expression candidates together with the user interface control information to the user, and obtain a selection operation by the user with respect to at least one of the language expression candidates,
construct, by using a prompt generation unit, a prompt sentence for generation that includes at least a selected language expression obtained by the candidate presentation unit, the emotional state estimated by the second recognition unit, and instructions regarding at least a character expression, a character action, a background, a color tone, and a style, on the basis of the selected language expression, the emotional state, and user attribute information and preference information,
input the prompt sentence for generation constructed by the prompt generation unit into a generative artificial intelligence model, generate visual content including at least an illustration-type image or a comic-type image by using a visual content generation unit, and output the visual content as a visual communication means for intention transmission by the user, and
update, by using a learning unit and a machine learning algorithm, at least a scoring parameter in the candidate generation unit, a user interface control parameter in the candidate presentation unit, and a rule for constructing the prompt sentence for generation in the prompt generation unit, on the basis of at least one of a presentation history of the language expression candidates, a selection history by the user, a usage situation of the visual content, and information related to the emotional state.

### (Supplementary 2)

The system according to supplementary 1,
wherein the processor is configured to
cause the second recognition unit to estimate, by using at least one of facial expression analysis with respect to a face region extracted from the image information, speech analysis with respect to acoustic features extracted from the acoustic information, and operation pattern analysis with respect to the operation history information, a plurality of emotion scores and at least one of a tension level and a confusion level, and
cause the learning unit to dynamically change at least one of the display count, the character size, and the spacing between the display elements in the candidate presentation unit on the basis of at least one of the tension level and the confusion level.

### (Supplementary 3)

The system according to supplementary 1,
wherein the processor is configured to
cause the candidate generation unit to generate, as an additional language expression candidate, a language expression by inputting, into a generative artificial intelligence model, a prompt sentence including a condition based on the outputs of the first recognition unit and the second recognition unit, to integrate the additional language expression candidate with the language expression candidates acquired from the language database unit, and to perform the scoring and the prioritizing on the integrated candidates, and
cause the prompt generation unit to cause the generative artificial intelligence model to complement or translate the prompt sentence for generation used in the visual content generation unit, and to output the complemented or translated prompt sentence for generation as an input for image generation.

### Application Example 2

### (Supplementary 1)

A system comprising a processor,
wherein the processor is configured to
acquire image data of a subject from an imaging unit,
perform image analysis including pose estimation and object detection on the image data to recognize a motion of the subject and to estimate intent information of the subject as a function of the recognized motion,
estimate an emotional state and an intensity of the emotional state of the subject based on at least one of the image data and acoustic data acquired from an acoustic acquisition unit, by performing time-series analysis of expression features, posture features, and acoustic features, generate a first prompt sentence for input to a first generative AI model based on the intent information and the emotional state, the first prompt sentence including conditions regarding language, style, and length,
obtain, from the first generative AI model, a plurality of language expression candidates in response to the first prompt sentence,
calculate priority information and urgency information for each of the plurality of language expression candidates based on at least the intent information, the emotional state, and user history information,
present, via a display interface, the plurality of language expression candidates to a user together with the priority information and the urgency information,
generate a second prompt sentence for input to a second generative AI model that generates image data, the second prompt sentence being generated based on at least one of the plurality of language expression candidates and the emotional state of the subject,
obtain, from the second generative AI model, visual communication image data representing a visual communication means corresponding to a state or need of the subject, in response to the second prompt sentence,
present, via the display interface, at least one of the plurality of language expression candidates and the visual communication image data to a support user,
acquire, via an input interface, selection information and evaluation information from the support user, the selection information indicating at least one selected language expression candidate from among the plurality of language expression candidates, and the evaluation information indicating an appropriateness of the selected language expression candidate or a recognition result,
store the selection information, the evaluation information, and selection history information of the subject in a storage unit as feedback data, and
update at least one parameter or weight coefficient of at least one model used for motion recognition, emotion recognition, or generation and ranking of the plurality of language expression candidates, based on the feedback data, so as to improve accuracy of recognition and presentation for the subject.

### (Supplementary 2)

The system according to supplementary 1,
wherein the processor is configured to
control the imaging unit configured as at least one of a fixed imaging apparatus and a portable imaging apparatus to capture, in real time, movements of hands of the subject, facial expressions of the subject, and surrounding objects,
apply a machine learning model to the image data and the acoustic data to estimate, with high accuracy, the motion and the emotional state of the subject, and
construct the first prompt sentence by including language settings and style conditions corresponding to a user profile, and obtain, from the first generative AI model, the plurality of language expression candidates in a plurality of languages.

### (Supplementary 3)

The system according to supplementary 1,
wherein the processor is configured to
cause a candidate presentation interface to display the plurality of language expression candidates together with the priority information and the urgency information in a format including at least one of text information and the visual communication image data,
control the second generative AI model to generate, as the visual communication image data, at least one of an illustration image and a comic-style image based on at least one of a selected language expression candidate or a highest-priority language expression candidate and the emotional state, and
update generation logic of the first prompt sentence and calculation logic of the priority information and the urgency information based on the selection information and the evaluation information received from the support user.

What is claimed is:

1. A system comprising:
circuitry configured to:
receive, via a communication interface coupled to a packet-switched network, image data captured by an imaging sensor of a terminal device, the image data representing gestures and objects associated with a user;
analyze the image data using a neural network to extract feature data and identify at least one object and at least one action performed by the user;
retrieve, from a storage device coupled to the packet-switched network, a plurality of candidate data records associated with the at least one identified object and the at least one identified action;
transmit the plurality of candidate data records to the terminal device via the communication interface;
construct a prompt data structure based on at least one selected candidate data record, transmit the prompt data structure to a generative neural network model, and receive generated image data from the generative neural network model; and
update at least one parameter of the neural network or a retrieval weight applied to the storage device based on interaction data received from the terminal device via the communication interface.

2. The system according to claim 1, wherein the circuitry receives the image data as a sequence of image frames and extracts spatial feature vectors from each image frame using a convolutional neural network, and inputs the spatial feature vectors as a time-ordered sequence to a temporal neural network model including at least one of a recurrent neural network, a long short-term memory network, or a temporal transformer to recognize the at least one action based on continuous posture changes of the user across the sequence of image frames.

3. The system according to claim 2, wherein the convolutional neural network includes a plurality of convolutional layers, activation functions, normalization layers, and pooling layers, and outputs for each image frame classification probabilities for object classes and posture states, and wherein the temporal neural network model applies attention mechanisms to the time-ordered sequence of spatial feature vectors to derive an action label and associated temporal boundaries.

4. The system according to claim 1, wherein the circuitry analyzes the image data by performing object detection to identify bounding box coordinates and class labels for the at least one object, and performs gesture recognition to identify at least one of a hand motion, an arm motion, a head motion, and a body posture change as the at least one action.

5. The system according to claim 1, wherein each candidate data record is stored in association with a language type identifier, a cultural attribute identifier, and a user profile identifier, and wherein the circuitry retrieves the plurality of candidate data records by querying the storage device using the at least one identified object, the at least one identified action, and attribute data corresponding to the user.

6. The system according to claim 1, wherein the circuitry computes a priority score for each candidate data record using a scoring model that receives as input the at least one identified action, the at least one identified object, a user-specific usage frequency, and environment attribute data, and transmits the plurality of candidate data records to the terminal device in an order determined by the priority scores.

7. The system according to claim 6, wherein the scoring model comprises at least one of a gradient-boosted decision tree model or a neural network that is trained on historical interaction data including selection frequencies and recency of usage, and wherein the circuitry updates weights of the scoring model using gradient-based optimization applied to batches of accumulated interaction data.

8. The system according to claim 1, wherein the circuitry constructs a text generation prompt data structure encoding the at least one identified action, environment attribute data, and user profile constraints, transmits the text generation prompt data structure to a text generative neural network model comprising a transformer architecture with a plurality of self-attention layers, and receives additional candidate data records generated by the text generative neural network model.

9. The system according to claim 1, wherein the generative neural network model comprises a diffusion-based image generation model with an encoder-decoder architecture, and wherein the circuitry constructs the prompt data structure to include a content specification describing the at least one selected candidate data record and a style specification defining at least one of a level of detail, a color scheme, and an illustration style, and performs iterative denoising steps using the diffusion-based image generation model to produce the generated image data.

10. The system according to claim 9, wherein the circuitry post-processes the generated image data to adjust at least one of contrast, artifact removal, and text overlay, and encodes the generated image data in a compressed format for transmission to the terminal device via the communication interface.

11. The system according to claim 1, wherein the circuitry is further configured to:
estimate an emotional state of the user based on at least one of the image data, acoustic data received from the terminal device, and operation history data received from the terminal device, using an emotion classification model; and
incorporate the estimated emotional state into at least one of the retrieval of the plurality of candidate data records and the construction of the prompt data structure.

12. The system according to claim 11, wherein the circuitry estimates the emotional state by extracting facial expression features from the image data using a convolutional neural network, extracting acoustic features including at least one of mel-frequency cepstral coefficients and fundamental frequency from the acoustic data, and extracting behavioral features including at least one of inter-event time intervals and input correction counts from the operation history data.

13. The system according to claim 11, wherein the circuitry generates user interface control information based on the estimated emotional state, the user interface control information specifying at least one of a display count of candidate data records, a character size, spacing between display elements, and a background style, and transmits the user interface control information to the terminal device together with the plurality of candidate data records.

14. The system according to claim 1, wherein the interaction data includes at least one of selection information indicating which candidate data record was selected by the user, evaluation information indicating a quality assessment of the generated image data, and communication success information indicating an outcome of a communication event, and wherein the circuitry stores the interaction data as learning data in the storage device.

15. The system according to claim 14, wherein the circuitry updates the at least one element of the prompt data structure by modifying at least one of a style specification and a content specification in the prompt data structure based on correlation between evaluation information and prompt data structure configurations accumulated in the learning data.

16. The system according to claim 1, wherein the terminal device compresses the image data using a video codec implemented in a system-on-chip encoder and transmits compressed image data as encrypted packets including timestamps and device identifiers to the circuitry via the communication interface and the packet-switched network.

17. The system according to claim 1, wherein the terminal device executes a lightweight object detection model locally to identify preliminary action labels and transmits the preliminary action labels together with reduced-resolution image data to the circuitry via the communication interface, and wherein the circuitry performs higher-level action interpretation and candidate data record retrieval based on the preliminary action labels and the reduced-resolution image data.

18. A system comprising:
a communication interface including a network interface controller coupled to a packet-switched network and configured to transmit and receive data packets;
a memory storing instructions, a neural network model including a plurality of convolutional layers and a temporal sequence model, a generative neural network model, and a scoring model; and
circuitry comprising one or more processors coupled to the memory and configured to execute the instructions to:
receive, via the communication interface, image data captured by an imaging sensor of a terminal device coupled to the packet-switched network, the image data representing gestures and objects associated with a user;
extract spatial feature vectors from the image data using the convolutional layers and input the spatial feature vectors to the temporal sequence model to identify at least one object and at least one action performed by the user;
retrieve, from a storage device coupled to the packet-switched network, a plurality of candidate data records associated with the at least one identified object and the at least one identified action, and compute a priority score for each candidate data record using the scoring model;
transmit the plurality of candidate data records with associated priority scores to the terminal device via the communication interface;
construct a prompt data structure encoding at least one selected candidate data record and style constraint parameters, transmit the prompt data structure to the generative neural network model, and receive generated image data from the generative neural network model;
transmit the generated image data to the terminal device via the communication interface; and
receive interaction data from the terminal device via the communication interface, and update at least one parameter of the scoring model and at least one element of the prompt data structure based on the interaction data.

19. The system according to claim 18, wherein the circuitry is further configured to estimate an emotional state of the user based on at least one of the image data and acoustic data received from the terminal device using an emotion classification model stored in the memory, and to incorporate the estimated emotional state into the construction of the prompt data structure and the computation of the priority score.

20. A method performed by circuitry of a server coupled to a packet-switched network via a communication interface, the method comprising:
receiving, via the communication interface, image data captured by an imaging sensor of a terminal device, the image data representing gestures and objects associated with a user;
analyzing the image data using a neural network to extract feature data and identify at least one object and at least one action performed by the user;
retrieving, from a storage device coupled to the packet-switched network, a plurality of candidate data records associated with the at least one identified object and the at least one identified action;
transmitting the plurality of candidate data records to the terminal device via the communication interface;
constructing a prompt data structure based on at least one selected candidate data record, transmitting the prompt data structure to a generative neural network model, and receiving generated image data from the generative neural network model; and
updating at least one parameter of the neural network or a retrieval weight applied to the storage device based on interaction data received from the terminal device via the communication interface.
